(19) United States
(12) Patent Application Publication
(10) Pub. No.: US 2026/0173128 A1
(43) Pub. Date: Jun. 18, 2026

(54) QUALITY OF SERVICE AND CHANNEL AWARE UPLINK TRANSMISSION

(71) Applicant: InterDigital Patent Holdings, Inc., Wilmington, DE (US)

(72) Inventors: Tuong Duc Hoang, Montreal (CA); Ghyslain Pelletier, Montreal (CA); Faris Alfarhan, Montreal (CA); Paul Marinier, Brossard (CA)

(73) Assignee: InterDigital Patent Holdings, Inc., Wilmington, DE (US)

(21) Appl. No.: 18/986,158

(22) Filed: Dec. 18, 2024

(51) Int. Cl. H04W 72/543; H04W 72/1263

(52) U.S. Cl. CPC H04W 72/543; H04W 72/1263

(57) ABSTRACT

Systems, methods, devices, and instrumentalities are described herein for quality of service (QoS) and channel aware uplink transmission. A wireless transmit/receive unit (WTRU) may receive configuration information including at least one trigger condition to perform transport block (TB) reconstruction transmission and one or more conditions associated with unit retransmission. The WTRU may construct a first TB and transmit the first TB. The WTRU may determine to perform TB reconstruction transmission based on the at least one trigger condition for TB reconstruction transmission being satisfied. The WTRU may determine a unit from the first TB to be retransmitted based on the one or conditions for retransmission being satisfied. The WTRU may construct a second TB including the unit from the first TB. The WTRU may transmit the second TB that includes the unit from the first TB.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, devices, and instrumentalities are described herein for quality of service (QoS) and channel aware uplink transmission.

A wireless transmit/receive unit (WTRU) may receive configuration information. The configuration information may include at least one trigger condition to perform transport block (TB) reconstruction transmission and one or more conditions associated with unit (e.g., control unit or data unit) retransmission. The WTRU may construct a first TB and transmit the first TB. The WTRU may determine to perform TB reconstruction transmission based on the at least one trigger condition for TB reconstruction transmission being satisfied. The at least one trigger condition to perform TB reconstruction transmission being satisfied may include an indication from a network being received, a quality of service (QoS) related condition being satisfied, a power related condition being satisfied, or a channel related condition being satisfied. The power related condition being satisfied may be a power difference between an initial transmission and retransmission being larger than a power difference threshold. The indication from the network may be determined to be received based on a received downlink control information (DCI) using a configured DCI format.

The WTRU may determine a unit from the first TB to be retransmitted based on the one or conditions for retransmission being satisfied. The one or more conditions associated with unit retransmission being satisfied may include a remaining delay budget of the unit being smaller than a latency threshold or a priority of the unit being smaller than a priority threshold. The remaining delay budget may be based on a remaining time until a discard timer expires at a higher layer or in a medium access control (MAC) layer. The unit may include a medium access control-control element (MAC-CE), a MAC service data unit (SDU), a radio link control protocol data unit (RLC PDU), or a MAC sub protocol data unit (subPDU).

The WTRU may construct a second TB. The second TB may include the unit from the first TB. The WTRU may transmit the second TB that includes the unit from the first TB. In examples, the second TB may be a subset of the first TB. The WTRU may transmit information associated with the second TB. The information with the second TB may include at least of: an indication of whether the second TB is a subset of the first TB; or an indication of at least one of a transport block size (TBS), a modulation and coding scheme (MCS), or a subset of resources used for transmitting the second TB. The WTRU may receive a scheduling grant. In examples, the second TB that includes the unit from the first TB may be transmitted in the resources indicated by the scheduling grant.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example procedure for a second TB-based transmission (e.g., a new-TB-based retransmission) for a control/data unit.

FIG. 3 illustrates an example of a WTRU selecting control/data unit(s) in an original TB to retransmit.

FIG. 4 illustrates an example of a WTRU segmenting the original TBs to multiple smaller TBs and retransmitting the reconstructed sub-TBs (e.g., newly reconstructed sub-TBs).

FIG. 5 illustrates an example of an original-TB-only multiplexing procedure for TB reconstruction.

FIG. 6 illustrates an original-TB-prioritized multiplexing procedure for TB reconstruction.

FIG. 7 illustrates an example associated with TB reconstruction transmission.

### DETAILED DESCRIPTION

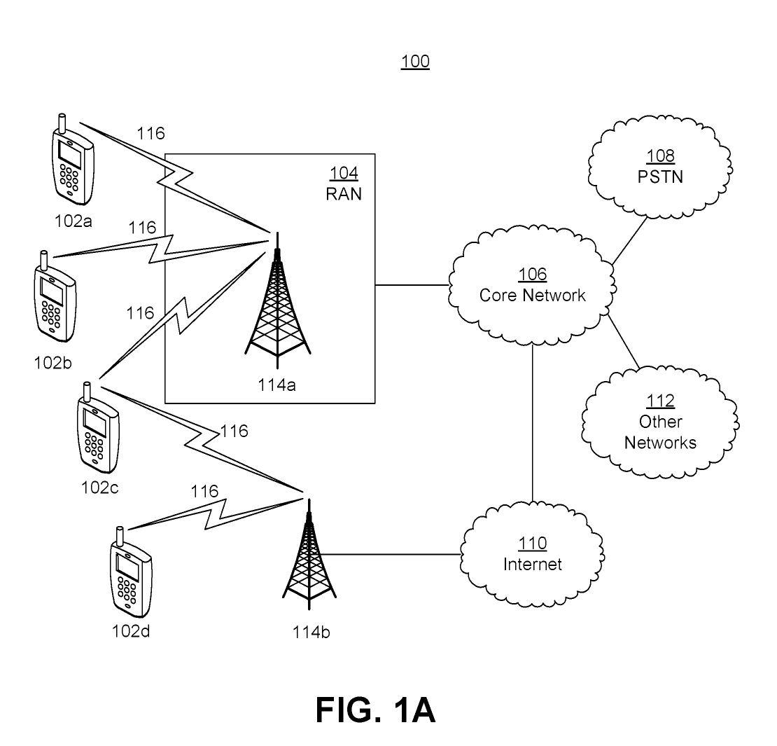

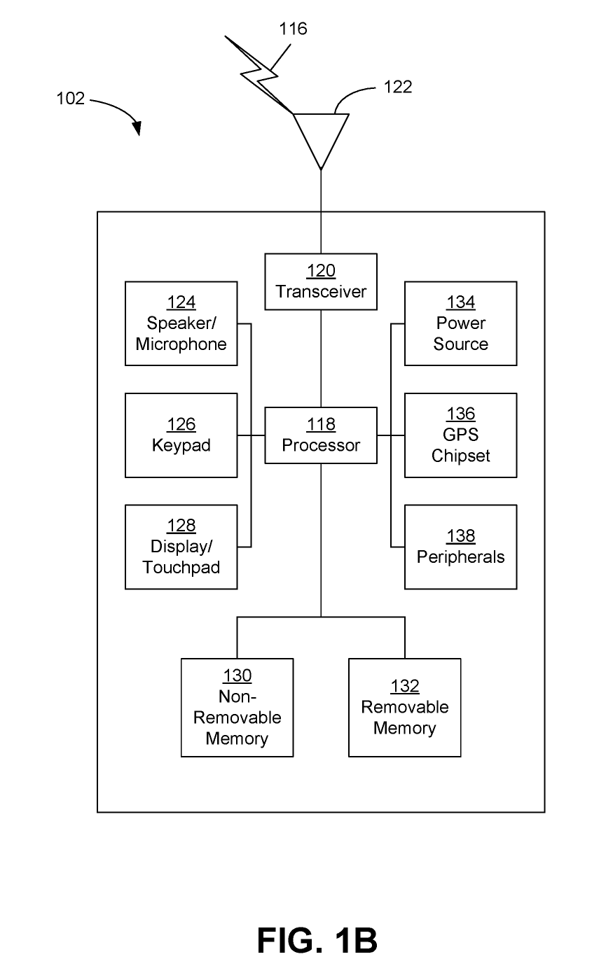

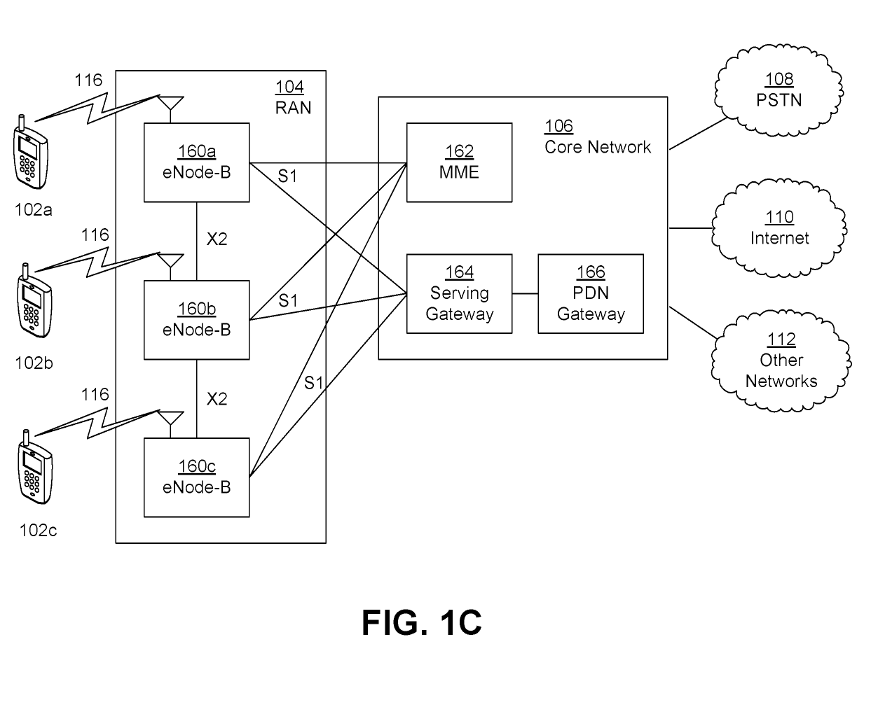

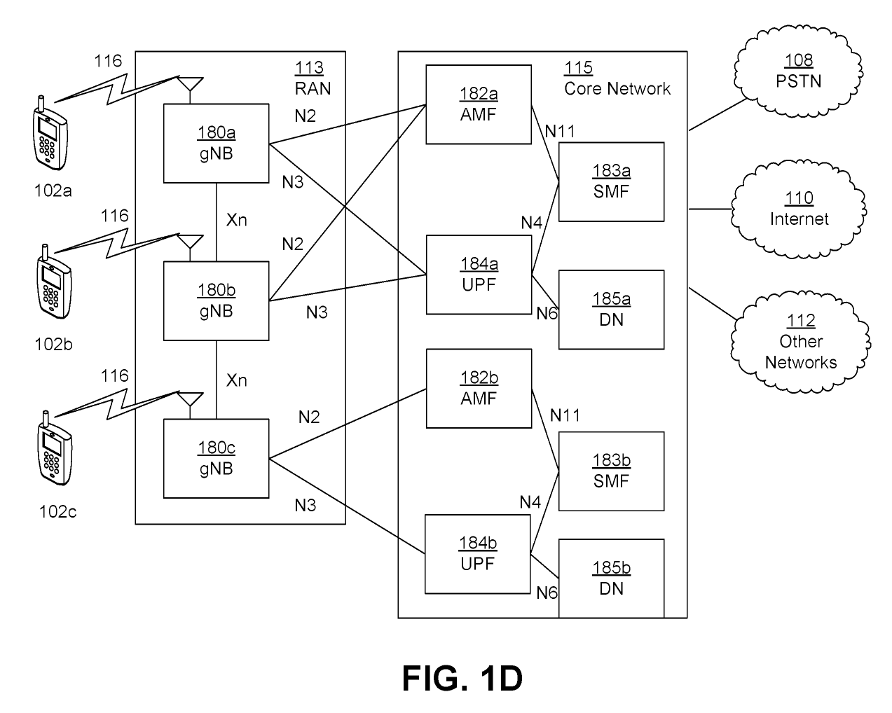

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), a Distributed Unit (DU), a Centralized Unit (CU), a gNB, relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three or more sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11afand 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc.

Systems, methods, devices, and instrumentalities are described herein for quality of service (QoS) and channel aware uplink transmission.

A wireless transmit/receive unit (WTRU) may receive configuration information. The configuration information may include at least one trigger condition to perform transport block (TB) reconstruction transmission and one or more conditions associated with unit (e.g., control unit or data unit) retransmission. The WTRU may construct a first TB and transmit the first TB. The WTRU may determine to perform TB reconstruction transmission based on the at least one trigger condition for TB reconstruction transmission being satisfied. The at least one trigger condition to perform TB reconstruction transmission being satisfied may include an indication from a network being received, a quality of service (QoS) related condition being satisfied, a power related condition being satisfied, or a channel related condition being satisfied. The power related condition being satisfied may be a power difference between an initial transmission and retransmission being larger than a power difference threshold. The indication from the network may be determined to be received based on a received downlink control information (DCI) using a configured DCI format.

The WTRU may determine a unit from the first TB to be retransmitted based on the one or conditions for retransmission being satisfied. The one or more conditions associated with unit retransmission being satisfied may include a remaining delay budget of the unit being smaller than a latency threshold or a priority of the unit being smaller than a priority threshold. The remaining delay budget may be based on a remaining time until a discard timer expires at a higher layer or in a medium access control (MAC) layer. The unit may include a medium access control-control element (MAC-CE), a MAC service data unit (SDU), a radio link control protocol data unit (RLC PDU), or a MAC sub protocol data unit (subPDU).

The WTRU may construct a second TB. The second TB may include the unit from the first TB. The WTRU may transmit the second TB that includes the unit from the first TB. In examples, the second TB may be a subset of the first TB. The WTRU may transmit information associated with the second TB. The information with the second TB may include at least of: an indication of whether the second TB is a subset of the first TB; or an indication of at least one of a transport block size (TBS), a modulation and coding scheme (MCS), or a subset of resources used for transmitting the second TB. The WTRU may receive a scheduling grant. In examples, the second TB that includes the unit from the first TB may be transmitted in the resources indicated by the scheduling grant.

A WTRU may retransmit a control/data unit in a second TB (e.g., new-TB-based retransmission). In examples, the WTRU may trigger a second TB-based retransmission (e.g., a new-TB-based retransmission) of a control/data unit based on indication from the network. In examples, the WTRU may trigger second TB-based retransmission (e.g., new-TB-based retransmission) based on the number of transmissions. In examples, the WTRU may trigger second TB-based retransmission (e.g., new-TB-based retransmission) based on the QoS associated with the control/data unit. In examples, the WTRU may trigger second TB-based retransmission (e.g., new-TB-based retransmission) for control/data units based on the QoS treatment profile. In examples, the WTRU may trigger second TB-based retransmission (e.g., new-TB-based retransmission) for a control/data unit based on the time elapse more than a threshold.

In examples, the WTRU may trigger as second-TB-based retransmission (e.g., new-TB-based retransmission) based on the amount (e.g., relative amount) of discarded control/data in the TB. In examples, the WTRU may trigger a second-TB-based retransmission (e.g., new-TB-based retransmission) based on an amount of delay-critical, high-importance/priority control/data.

In examples, the WTRU may trigger TB reconstruction based on indication from the network. In examples, the WTRU may trigger TB reconstruction based on the HARQ ID associated with the TB. In examples, the WTRU may trigger TB reconstruction based on the number of (re)transmissions associated with the TB. In examples, the WTRU may trigger TB reconstruction based on the QoS associated with the TB. In examples, the WTRU may trigger TB reconstruction based on the QoS treatment profile of the control/data unit in the TB. In examples, the WTRU may trigger TB reconstruction based on a transmission power-related condition. In examples, the WTRU may perform TB reconstruction based on a transmission channel-related condition. In examples, the WTRU may trigger TB reconstruction based on the amount (e.g., relative amount) of control/data subject for retransmission. In examples, the WTRU may trigger TB reconstruction based on the amount (e.g., relative amount) of discarded control/data in the TB. In examples, the WTRU may trigger TB reconstruction based on whether segment is required for TB reconstruction. In examples, the WTRU may trigger TB reconstruction based on the grant size. In examples, the WTRU may trigger TB reconstruction based on the TB size.

The WTRU may determine whether to discard a TB. The WTRU may determine which multiplexing procedure to use. The WTRU may determine the priority (e.g., relative priority) associated with control/data units (e.g., each control/data unit). The WTRU may determine whether a grant may be used for a TB reconstruction transmission. The WTRU may determine which TB to prioritize for TB reconstruction transmission. The WTRU may determine the parameters associated with the TB reconstruction and transmission. The WTRU may perform a multiplexing procedure for TB reconstruction transmission.

In examples, the WTRU may perform an original-TB-only multiplexing procedure for TB reconstruction. In examples, the WTRU may perform an original-TB-prioritized multiplexing procedure for TB reconstruction.

The WTRU may determine which control/data unit to multiplex in a TB for TB reconstruction. The WTRU may determine whether to drop/discard a control/data unit. The WTRU may report the set(s) of dropped/discarded control/data unit(s). The WTRU may multiplex control/data units in a TB (e.g., a new TB) considering/prioritizing retransmission control/data units. The WTRU may be configured with one or more QoS treatment profile groups. The multiplexing procedure may consider/prioritize the units from the same QoS treatment profile group. The WTRU may determine which QoS treatment profile group to consider/prioritize in a multiplexing procedure.

The WTRU may report the information about control/data unit for (re)transmission to the network. The WTRU may be configured with one or multiple MAC-CE formats to report RBSR information. The WTRU may trigger SR/RBSR reporting based on a configured trigger condition. The WTRU may be configured with a dedicated UCI (e.g., SR) for indicating the availability of retransmission buffer. The WTRU may cancel a pending reporting of RBSR.

Examples of uplink retransmissions at higher layers (e.g., RLC/PDCP) are provided herein. Uplink retransmission of a SDU (e.g., PDCP SDU and RLC SDU) at a higher layer (e.g., RLC/PDCP) may be supported. The retransmission of a SDU may rely on status reporting (e.g., an RLC/PDCP status report). The network may transmit (e.g., first transmit) a status report using an RLC control PDU to indicate reception status of the transmitted RLC SDUs. RLC SDUs (e.g., each RLC SDU) in acknowledge mode (AM) may have an associated sequence number (SN). The network/UE may (e.g., may then) detect the missing RLC SDUs based on the SN gaps between two successfully received RLC SDUs. The WTRU may (e.g., may then) consider the missing RLC SDUs for retransmission. For RLC SDUs (e.g., each RLC SDU) in AM mode, the WTRU may keep the replicated version in an RLC retransmission buffer (e.g., after submitting the RLC SDUs (e.g., each RLC SDU) to lower layer for multiplexing).The retransmitted RLC SDU may follow a logical channel prioritization (LCP) procedure (e.g., the normal LCP procedure) to be multiplexed in a TB and the retransmitted RLC SDU may be prioritized over the initial RLC SDU (e.g., after the PDU is considered for retransmission).

Retransmission of a TB (e.g., MAC PDU) may be supported in MAC/PHY. The WTRU may perform retransmission of a TB based on repetition and HARQ-based retransmission. For repetition, the WTRU may repeat the transmission of a TB for a configured/indicated number of times. The WTRU may perform repetition of a TB using a dynamic grant and/or configured grant. For repetition, the network controls the number of repetitions for TBs (e.g., each TB) regardless of the data multiplexed in the TB.

For HARQ-based retransmission, the WTRU may indicate whether to retransmit a TB based on dynamic scheduling (e.g., using DCI). The DCI may indicate whether the WTRU retransmits a TB associated with a HARQ ID or transmits an entire TB (e.g., a new TB) associated with the HARQ ID using an NDI field. Which HARQ ID to schedule and whether the HARQ ID is for an entire TB (e.g., new TB) or for a retransmission of a TB is purely based on the network scheduling decision (e.g., in this scheme). The WTRU may be not aware of whether a certain TB is successfully received or not (e.g., in addition). For both repetition and HARQ retransmission, the TB size may remain the same for (re)transmissions (e.g., each (re)transmission).

CBG-based retransmission may be supported. CBG-based retransmission may enable the WTRU/network to retransmit the data per CBG granularity. For CBG-based (re)transmission, the WTRU may encode one TB to multiple CBGs, with associated CRCs per CBG. In uplink transmission, the network may determine ACK/NACK status per CBG, and the network may request the WTRU to retransmit a certain CBG. In downlink transmission, the WTRU may provide the ACK/NACK status per CBG, and the network may need to retransmit the error CBGs instead of retransmitting all TB.

Examples of BSR/DSR reporting are provided herein. Regarding the WTRU reporting to support network scheduling, a regular BSR may be triggered when data (e.g., new data) of an RB/LCH or data with higher priority of an RB/LCH arrives. A delay status report (DSR) MAC-CE may be (e.g., may also be) introduced (e.g., to support informing the network regarding the delay information). The WTRU may trigger sending DSR to the network when data in the PDCP/RLC buffer becomes delay critical (e.g., the delay budget (e.g., the remaining delay budget) being smaller than a configured threshold). If the data/control is pushed to a HARQ buffer for (re)transmission, the delay information of such data/control may not be considered.

RLC may be a protocol that performs segmentation to adapt PDUs to the grant/TB size. RLC may be (e.g., may also be) responsible for (re)transmissions if HARQ fails (e.g., NACK to ACK errors or if a HARQ operating point is not met). RLC may be designed with best effort (e.g., TCP) and conversational services (e.g., VoIP, video) in mind. A portion of data may require both very low latency but also very high reliability (e.g., given the latency bounds of immersive services). Some control elements multiplexed in a TB (e.g., MAC-CE) may (e.g., may also) require additional reliability and low latency link level adaptation (e.g., for the purpose of channel state information, reconfiguration, and/or link adaptation).

In examples, the retransmission loops (e.g., additional retransmission loops) of RLC AM above HARQ and/or PDCP retransmission (e.g., at change of cell) may no longer be fast enough for such data or control elements. It may be desirable to improve the reliability and latency mechanisms of HARQ for such requirements.

CBG-based retransmission may require the WTRU to successfully transmit CBG (e.g., all CBG) associated with a TB for the gNB to successfully decode the TB. CBG may not enable self-decoding of user plane data inside the CBG. Dropping one CBG may result in the error for the whole TB.

Control data transported by the MAC layer (e.g., for the purpose of channel state information, reconfiguration, and/or link adaptation) may (e.g., may also) benefit for enabling very low latency link adaptation in the scheduler.

Examples of transmitting data and/or control again to improve the reliability and latency performance are provided herein.

A WTRU may (e.g., if the WTRU receives a grant for retransmission of one or more control/data units in a TB) select a set of control/data units (e.g., a MAC-CE, a RLC SDU, a MAC SDU) from the TB (e.g., original TB) for a TB reconstruction transmission in a scheduled resource based on a triggering condition (e.g., an indication from the network, a QoS of the TB, a power transmission condition, a channel condition) for TB reconstruction transmission being satisfied.

A WTRU may receive configuration information. The configuration information may include (e.g., indicate) at least one trigger condition for TB reconstruction transmission and/or one or more conditions for retransmission of control/data units (e.g., retransmission of control data/units from a first TB (e.g., an original TB)). The one or more trigger conditions for TB reconstruction transmission may include an indication from the network, a QoS of the TB related condition (e.g., latency, priority, importance thresholds), a power and/or channel related condition. For the indication from the network, the WTRU may be configured with a DCI format for implicit or explicit indication to retransmit one or more control/data units in a TB (e.g., sub-TB retransmission). For the QoS of the TB related condition (e.g., latency, priority, importance thresholds), the WTRU may be configured with a latency threshold. The WTRU may transmit a control/data unit again (e.g., in a second TB/new TB) if the delay budget (e.g., remaining delay budget) of the data/control unit is smaller than the latency threshold. For the power and/or channel related condition, the WTRU may be configured with a Tx power difference threshold, in which the WTRU may perform sub-TB retransmission of one or more control/data units if the Tx power difference between the initial and the retransmission is larger than the power difference threshold.

The one or more conditions for retransmission of a control/data units from the original TB may include the WTRU retransmitting the control/data units if the delay budget (e.g., remaining delay budget) is smaller than a configured threshold (e.g., latency threshold) or the WTRU retransmitting the control/data units if an associated priority is smaller than a configured threshold (e.g., priority threshold). The remaining delay budget may be based on a remaining time until a discard timer expires at higher layers (e.g., PDCP) or in a MAC layer.

The WTRU may construct a TB (e.g., a first TB or an original TB) and may perform initial transmission of the TB (e.g., the first TB or the original TB) (e.g., based on receiving a grant for initial transmission of a TB). The WTRU may receive a scheduling grant. The scheduling grant may be used to retransmit one or more control/data units of the TB (e.g., the first TB or the original TB).

The WTRU may determine to perform TB reconstruction transmission based on the at least one trigger condition for TB reconstruction transmission being satisfied. The WTRU may determine which control/data units (e.g., MAC-CE, MAC SDU, MAC subPDU) of the first TB (e.g., the original TB) to retransmit based on the one or more trigger conditions to retransmit the control/data unit being satisfied. The one or more triggering conditions for TB reconstruction transmission being satisfied may include an indication from the network being received, a QoS related condition being satisfied, a power related condition being satisfied, or a channel related condition being satisfied. The indication from the network may be a DCI format to use for (e.g., configured to indicate) the retransmission of the one or more control/data units. The power related condition being satisfied may be a power difference between an initial transmission and retransmission being larger than a power difference threshold. In examples, the QoS related condition being satisfied may be a delay budget of the one or more control/data units being smaller than a latency threshold. In examples, the QoS related condition being satisfied may be a priority of the one or more control/data units being smaller than a priority threshold. The one or more conditions for retransmission of one or more control/data units being satisfied may include a remaining delay budget of the one or more control/data units being smaller than a latency threshold or a priority of the one or more control/data units being smaller than a priority threshold. The one or more control/data units may include a MAC-CE, a MAC SDU, a RLC PDU, or a MAC subPDU.

The WTRU may construct a TB (e.g., a second TB) including the control/data units to be retransmitted (e.g., from the first TB). The WTRU may transmit the determined TB (e.g., the second TB). The second TB may be a subset of the TB or the entire TB. The second TB, including the one or more control/data units retransmitted from the first TB, may be transmitted in the scheduled grant.

The WTRU may use the same or a different hybrid automatic repeat-request (HARQ) process ID to transmit the control/data unit again (e.g., based on network indication). If the WTRU uses the same HARQ ID, the WTRU may (e.g., may need to) flush the existing HARQ ID and discard other data. If the WTRU uses a different HARQ ID, the network may (e.g., may need to) indicate which HARQ ID and the relationship with the existing HARQ ID. For example, a type (e.g., new type) of NDI may be used to tell the WTRU to flush the HARQ process but keep the data in the buffer.

The WTRU may indicate (e.g., transmit) the information associated with the second TB (e.g., new TB) (e.g., in a separate part of the resource (e.g., uplink control information (UCI))). The information associated with the second TB may include at least one of whether the WTRU retransmits a subset of a TB or the entire TB (e.g., whether the second TB is a subset of the first TB or is an entire TB); or one or more of (e.g., a new) TBS, MCS, or subset of resources used for transmission.

The examples described herein may enable the WTRU to accelerate (re)transmission of a subset of a TB at a lower layer (e.g., PHY) instead of waiting for a higher layer (e.g., RLC/PDCP) (re)transmission, which may incur long delay. The examples herein may help the WTRU to deliver important data within the latency requirement.

The network may be used to describe the base station serving the WTRU, an eNB, a gNB, a 6G gNB, a transmission and reception point (TRP), a network entity such as a location management function (LMF), a coordinator device (e.g., a relay WTRU, another WTRU, a group coordinator).

The term “the WTRU is configured with something” may be used to indicate that the WTRU is preconfigured with something, or the WTRU receives the network configuration of something. The network configuration may be received via a system information block (SIB), a dedicated radio resource control (RRC) message, MAC-CE, or DCI. For example, the WTRU configured with a threshold may be equivalent to the WTRU is preconfigured (e.g., the WTRU stores the configuration) with the threshold or the WTRU receives, from the network, via SIB, RRC, MAC-CE, and/or DCI, the threshold.

Indication from the network and configuration from the network may be used interchangeably. Both terminologies may be used to describe the WTRU receiving the scheduling decision from the network. The WTRU may receive an indication/configuration from the network via any downlink reception such as SIB, NAS, RRC, MAC-CE, and/or DCI.

A control/data unit may be used to represent/indicate/describe a control unit, a data unit, and a control and data unit. A control and data unit may be the unit including both a control bit and a data bit. A unit in control/data unit may be used to represent/indicate/describe one or any combination of the granularities for control/data treatment from the WTRU and the network. One unit granularity may be at least one of the following: one control/data bit; one SDU (segment) in any protocol layer (e.g., SDAP/PDCP/ RRC/RLC/MAC SDU (segment), MAC-CE, TB (segment), CBG, CB, UCI); a protocol data unit (PDU) (segment) in any protocol layer (e.g., a SDAP/PDCP/ RRC/RLC/MAC PDU-segment); one or more subsets of a PDU set; one PDU set; multiple inter-dependent PDU sets; or a data burst.

A control unit may be used to represent/indicate/describe a control unit in any layer (e.g., NAS, SDAP, PDCP, RLC, MAC, PHY). For example, a control unit may be associated with control bits in a SRB for NAS, a RRC message, a control PDCP PDU/SDU, a control RLC PDU/SDU, a MAC-CE, uplink control information (UCI), etc.

A data unit may be used to represent/indicate/describe a data unit from user plane in any layer (e.g., NAS, SDAP, PDCP, RLC, MAC, PHY). For example, a data unit may be associated with a data bit in a QoS flow, a data bit in a data radio bearer (DRB), a PDCP SDU/PDU, a RLC SDU/PDU, a MAC SDU/PDU, a TB (segment), a code block/code block group (CB/CBG), etc.

A QoS associated with a control/data unit may be used to indicate/describe one or more of the following: one or more parameters (e.g., QoS) associated of an SDU/PDU (segment) associated with the control/data unit; one or more parameters of a PDU set (e.g., QoS parameters) associated with the control/data unit; one or more parameters of a data burst associated with the control/data unit; or one or more redundancy parameters (e.g., Application Layer Forward Error Correction ratio (AL-FEC ratio)) associated with the control/data unit.

For the one or more parameters (e.g., QoS) of an SDU/PDU (segment) associated with the control/data unit, the control/data unit may belong to the SDU/PDU (segment) or the SDU/PDU (segment) may belong to the control/data unit. The parameters of an SDU/PDU (segment) may include one or more of the following. The parameters of an SDU/PDU (segment) may include the SDU/PDU importance (e.g., which may be used to indicate the importance of the PDU set associated with the PDU, the relative importance of the PDU in the PDU set, the relative importance of the PDU in a data burst, and/or the relative importance of the PDU in the QoS flow). The parameters of an SDU/PDU (segment) may include the (relative) priority associated with the SDU/PDU. The parameters of an SDU/PDU (segment) may include the latency requirement of the SDU/PDU (segment) (e.g., which may include a packet delay budget (PDB) and/or a remaining PDB). The parameters of an SDU/PDU (segment) may include the synchronization window, which may be used to describe the synchronization requirement between two or more interdependent SDU/PDUs. To satisfy the QoS requirement of an XR service, the WTRU may (e.g., may need to) deliver two interdependent SDU/PDUs within the synchronization window. When transmitting/receiving of the first SDU/PDU, the WTRU may (e.g., may need to) transmit/receive the second inter-dependent SDU/PDU within the synchronization window). The parameters of an SDU/PDU (segment) may include the remaining synchronization window and/or the remaining time to serve (e.g., to transmit/receive) the SDU/PDU, which may be used to describe the remaining time to serve the second SDU/PDU upon transmission/reception of the first inter-dependent SDU/PDU (e.g., due to synchronization requirement between the SDU/PDU and another inter-dependent SDU/PDU). The parameters of an SDU/PDU (segment) may include the reliability requirement of the SDU/PDU (e.g., Packet Error Rate (PER)). The parameters of an SDU/PDU (segment) may include the maximum Data Burst Volume (MDBV). The parameters of an SDU/PDU (segment) may include the traffic type of the SDU/PDU (segment) (e.g., periodic vs. aperiodic). The parameters of an SDU/PDU (segment) may include the periodicity of the PDU/PDU-segment. The parameters of an SDU/PDU (segment) may include the size of the PDU/PDU-segment.

For the one or more parameters of a PDU set (e.g., QoS parameters) associated with the control/data unit, the control/data unit may belong to the PDU set or the PDU set may belong to the control/data unit. The parameters of the PDU set may include one or more of the following. The parameters of the PDU set may include PDU set importance (PSI), which may be used to indicate the relative importance of a PDU set compared to other PDU sets within a QoS flow. The parameters of the PDU set may include the PDU set priority. The parameters of the PDU set may include the synchronization window (e.g., the remaining synchronization window), which may be used to describe the synchronization requirement between two or more inter-dependent PDU sets or the synchronization requirement between one PDU set and one or more other PDUs. For example, to satisfy the QoE requirement of an XR service, the WTRU may (e.g., may need to) deliver two interdependent PDU sets within the synchronization window. When transmitting/receiving the first PDU set, the WTRU may (e.g., may need to) transmit/receive the second inter-dependent PDU set within the synchronization window. The parameters of the PDU set may include the latency requirement associated with the PDU set. The PSDB (e.g., the remaining PSDB) may be used to indicate the maximum time between reception of the first PDU and the successful delivery of the last arrived PDU of a PDU set. The parameters of the PDU set may include the PDU set Integrated handling indication (PSIHI), which may indicate whether PDUs (e.g., all PDUs) of the PDU set are needed for the usage of PDU set by application layer.

The parameters of the PDU set may include the type of the PDU set. The type of the PDU set may include a first type of PDU set, a second type of PDU set, or a third type of PDU set. The first type of PDU set may require reliable delivery of PDUs (e.g., all PDUs) in the set. The second type of PDU set may include the transmission of a PDU set being unsuccessful when at least one (e.g., possibly specific) PDU fails transmission. The third type of PDU set may include the transmission of a PDU set being successful when X PDUs of the PDU set of Y PDUs are received (e.g., if Forward Error Correction (FEC) is used or if additional layered encoding is used and assigned to the same PDU set).

The parameters of the PDU set may include the reliability requirement of a PDU set such as a PDU Set Error Rate (PSER), which may be used as a trigger condition for TB reconstruction and/or a condition for retransmission of a control/data unit.

The parameters of the PDU set may include the volume of the PDU set. The volume of the PDU set may include the size of each PDU and/or the number of PDUs in the PDU set. The parameters of the PDU set may include the Type of PDU set (e.g., periodic vs. aperiodic). The parameters of the PDU set may include the periodicity of the PDU set.

For the one or more parameters of a data burst associated with the control/data unit, the one or more parameters of a data burst may include the volume of the data burst. The volume of the data burst may include one or more of the following: the size of each PDU in the data burst; the number of PDU sets in the data burst; or the volume of each PDU set in the data burst.

For the one or more redundancy parameters (e.g., Application Layer Forward Error Correction ratio (AL-FEC ratio) associated with the control/data unit, the one or more redundancy parameters may be used to indicate the number of required PDUs to decode the PDU set. For example, a control/data unit may be a PDU set in which the receiver may (e.g., may need to) successfully receive at least K out of N PDUs in the PDU set to successfully decode the PDU set (e.g., successfully decode a video frame at an application layer). K or the ratio between K and N (K/N) may be used as one of the QoS parameters for the PDU set to represent the redundancy parameter for the PDU set. For example, a control/data unit may be a PDU set which may include multiple subsets of the PDU set. The WTRU may be required to successfully transmit a ratio or a certain number of PDUs of subsets (e.g., each subset) of the PDU set to satisfy a certain QoS requirement. The ratio of PDUs (e.g., each PDU) may be used as one or more QoS parameters for the PDU set to represent the redundancy parameters for the PDU set.

An application may provide one or more IP flows for transmission over a medium. IP flows (e.g., each IP) flow may (e.g., may then) go through a transport layer protocol (e.g., TCP/IP, QUIC, RTP, MOC etc). IP flows (e.g., IP flow) (e.g. a PDU session) may go through a RAN core network, which may map the IP flows to a RAN data flow or a RAN data set. For RAN data flows (e.g., each RAN data flow), the core network may attach at least one of some QoS requirements, a QoS metric, or a range of QoE metrics.

A RAN data flow may represent a logical association between data units (e.g., originating from the same IP flow). Such association may be based on such data units being associated to the same IP flow, application flow, or having the same association packet marked either by the core network or the application. Some RAN data flows may not originate from a user application, but rather from one or more of a control plane (e.g., control data and RAN signaling and configurations), an intelligence plane (e.g., data collected from AI/ML services), a computing plan (e.g., used for native computing for computing services), a system plane (e.g., data originating within the RAN e.g. )due to sensing or positioning services)), or a security plane.

The WTRU may assign a QoS class to control data/units (e.g., each control/data unit) within a RAN data flow for the purpose of characterization of how control/data should be transmitted. A protocol plane may include a control/data unit classification function for a QoS class marking throughout the protocol chain. The QoS class may be determined in a layer according to one or more configured or predefined rules. Such QoS classes may be used in various layers within the data plan protocol chain for achieving a certain QoS requirement. QoS classes (e.g., each QoS class) may be associated with a QoS treatment profile in the RAN, which may be configured semi-statically or change dynamically. QoS treatment profiles (e.g., each QoS treatment) profile may include a number of parameters to control the RAN treatment of the data transmission/reception and a number of metrics to achieve the QoS/QoE level for a given layer in the protocol chain. Each QoS class or QoS treatment profile may be associated and/or configured with one or more QoS parameters (e.g., at least one of a priority, an importance level, a delay bound, a reliability level, a guaranteed bit rate, a maximum bit rate, or a maximum packet loss rate).

QoS, QoS class, and QoS treatment profile associated with a control/data unit may be used interchangeably.

QoS treatment profile group, QoS group, and QoS class group may be used interchangeably. QoS treatment profile group may be used to describe the group of QoS treatment profile IDs. QoS group may be used to describe the group of QoS. QoS class group may be used to describe a group of QoS class IDs.

Delay-critical control/data may be used to indicate the control/data having the delay budget (e.g., remaining delay budget) being smaller than a configured threshold.

High importance control/data may be used to indicate the control/data associated with a QoS and/or QoS treatment profile having the importance being greater than a configured threshold. A high priority control/data may be used to indicate the control/data associated with a QoS and/or QoS treatment profile having the priority being greater than a configured threshold.

TB reconstruction may be used to describe the procedure in which the WTRU multiplex a second TB (e.g., new TB) from data/control from at least of an original TB and transmits the second constructed TB (e.g., newly constructed TB). TB reconstruction and TB reconstruction transmission may be used interchangeably. Both terminologies may be used to describe the procedure in which the WTRU may first reconstruct the second TB (e.g., new TB) from the original TB and then transmit the second (re)constructed TB (e.g., newly (re)constructed TB).

Examples for multiplexing of data/control for (re)transmission and examples for selective retransmission of control/data are provided herein.

In examples, the WTRU may first perform one or more transmissions (e.g., one initial transmission) of a control/data unit in a TB. The WTRU may (e.g., may then) keep the control/data unit in its buffer (e.g., RLC/MAC/HARQ buffer) for potential future retransmission. The WTRU may (e.g., may then) trigger retransmission of the control/data unit. The WTRU may not have a grant to construct a TB for retransmission of the control/data yet. The WTRU may (e.g., may then) consider the control/data unit as a control/data unit subject for retransmission. If a grant for retransmission of the control/data unit is available, the WTRU may (e.g., may then) multiplex the control/data unit in another TB for potential retransmission.

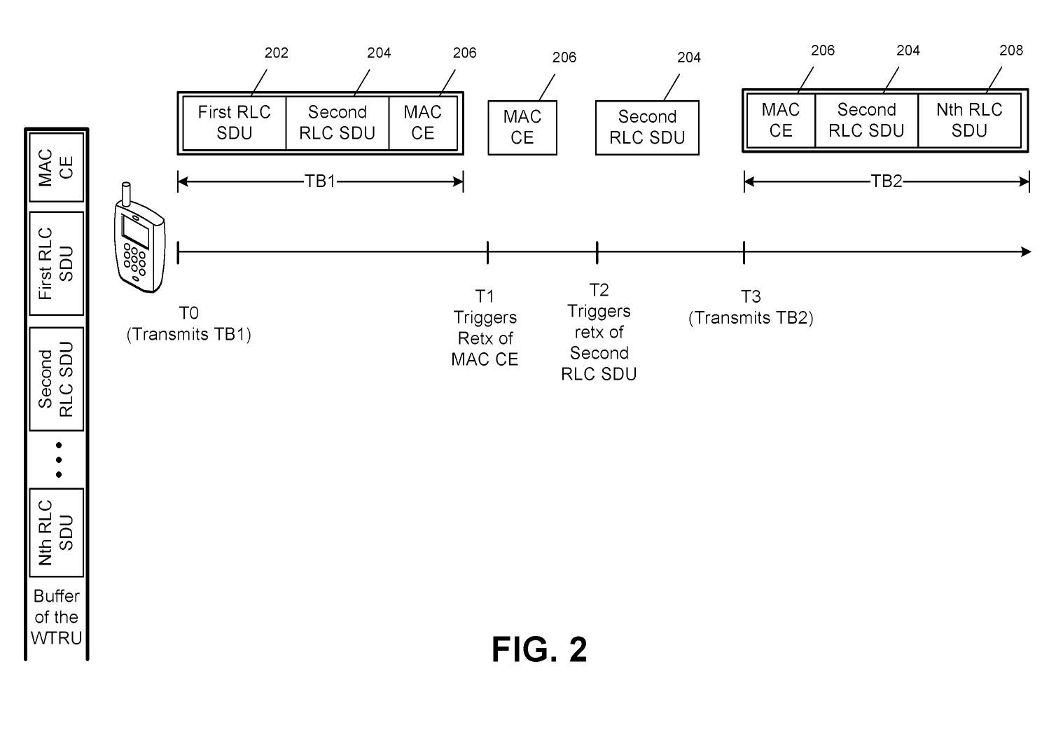

FIG. 2 illustrates an example procedure for a second TB-based transmission (e.g., a new-TB-based retransmission) for a control/data unit. As shown in FIG. 2, the WTRU may first have a set of control/data units in its buffer for transmission. The WTRU may (e.g., may first) construct transport block TB1, which may include a first RLC SDU 202, a second RLC SDU 204, and a MAC-CE 206. At time T0, the WTRU may transmit the transmit block TB1. The WTRU may trigger a second-TB-based transmission (e.g., new-TB-based retransmission) for the MAC-CE 206 and the second RLC SDU 204 at time T1 and T2, respectively (e.g., if the second-TB-based transmission (e.g., new-TB-based retransmission) of each control/data unit is satisfied. The WTRU may (e.g., may then) receive a grant for uplink transmission at time T3. The WTRU may construct transport block TB2, which may include the MAC-CE 206 and the second RLC SDU 204. The WTRU may (e.g., may then) transmit transport block TB2 at time T3. Transport block TB2 may include both a control/data unit subject for initial transmission and retransmission. For example, the MAC-CE and second RLC SDU may be the control/data units subject for retransmission, and the Nth RLC SDU 208 may be the control/data unit subject for initial transmission.

The WTRU may be configured with one or more triggering conditions to retransmit the control/data unit in a TB (e.g., a new-TB-based retransmission). If the triggering condition for TB-based retransmission (e.g., new-TB-based retransmission) of a control/data unit is satisfied, the WTRU may (e.g., may then) trigger a second-TB-based (e.g., new-TB-based) retransmission for the control/data unit. For example, the WTRU may construct a second TB (e.g., new TB) including the control/data unit and perform transmission of the second constructed TB (e.g., newly constructed TB) before an uplink grant. The WTRU may be configured with at least one the following triggering conditions for second-TB-based retransmission (e.g., new-TB-based retransmission): an indication from the network; the number of (re)transmissions associated with the control/data unit; the QoS associated with the control/data unit; the QoS treatment profile associated with the control/data unit; the time elapse from initial transmission of the control/data unit; or the amount (e.g., relative amount) of discarded/obsolete control/data units in the associated TB.

The WTRU may trigger a second-TB-based retransmission (e.g., new-TB-based retransmission) for a control/data unit based on an implicit/explicit indication from the network. For example, the WTRU may (e.g., may first) perform one or more transmissions of a TB including the considered control/data unit. The WTRU may (e.g., may then) receive an indication from the network to retransmit one, multiple, or all control/data units in the TB. Such an indication may be received via DCI, MAC-CE, and/or RRC. For example, the WTRU may receive an indication from the network that the network has failed to receive the TB (e.g., NACK for the TB). The WTRU may be further indicated to stop HARQ-based retransmission for the original TB. For example, the WTRU may trigger a second-TB-based retransmission (e.g., new-TB-based retransmission) for the control/data units included in the original TB. The control/data units in the TB may be multiplexed in multiple TBs (e.g., new TBs). For example, the WTRU may determine which control/data units in the original TB to retransmit based on another condition such as the QoS (e.g., the delay budget (e.g., the remaining delay budget)) of the control/data unit, and/or the QoS treatment profile associated with the control/data unit.

The WTRU may trigger a second-TB-based retransmission (e.g., new-TB-based retransmission) for a control/data unit based on the number of transmissions associated with the control/data unit in a TB. For example, the WTRU may be configured with a maximum number of transmissions for a control/data unit in a TB. Such a maximum number of transmissions may be associated with the type of control unit and/or the QoS associated with the data unit. The WTRU may (e.g., may then) trigger a second-TB-based retransmission (e.g., new-TB-based retransmission) for the control/data unit if the number of transmissions made for the control/data unit in a TB is greater than a configured threshold.

The WTRU may trigger a second-TB-based retransmission (e.g., new-TB-based retransmission) for a control/data unit based on the QoS associated with the control/data unit. For example, the WTRU may trigger a second-TB-based retransmission (e.g., new-TB-based retransmission) for a control/data unit if the delay budget (e.g., remaining delay budget) of the control/data unit is smaller than a configured threshold. For example, the WTRU may trigger a second-TB-based retransmission (e.g., new-TB-based retransmission) for a control/data unit if the priority of the control/data unit is larger than a configured threshold. For example, the WTRU may trigger a second-TB-based retransmission (e.g., new-TB-based retransmission) for a control/data unit if the importance of the control/data unit is larger than a configured threshold.

The WTRU may trigger a second-TB-based retransmission (e.g., new-TB-based retransmission) for a control/data unit based on the QoS treatment profile associated with the control/data unit. For example, the WTRU may be configured with a second-TB-based retransmission (e.g., new-TB-based retransmission) enabled/disabled for each QoS treatment profile. The WTRU may (e.g., may then) determine to perform a second-TB-based retransmission (e.g., new-TB-based retransmission) for a control/data unit TB if it is associated with a second-TB-based (e.g., new-TB-based) retransmission enabled profile.

For example, the WTRU may be configured with a second-TB-based retransmission (e.g., new-TB-based retransmission) enabled/disabled for each RB/LCH/PDU-set. The WTRU may (e.g., may then) determine to trigger a second-TB-based retransmission (e.g., new-TB-based retransmission) for a control/data unit if it is an associated second-TB-based (e.g., new-TB-based) retransmission enabled RB/LCH/PDU-set.

For example, the WTRU may be configured with a second TB-based retransmission (e.g., new-TB-based retransmission) enabled/disabled for each MAC-CE. The WTRU may (e.g., may then) determine to perform a second-TB-based retransmission (e.g., new-TB-based retransmission) for a MAC-CE if the WTRU is configured with an enabled second-TB-based (e.g., new-TB-based) retransmission. For example, the WTRU may be configured with one or more MAC-CEs to report CSI and/or HARQ ACK/NACK. The WTRU may be configured with one MAC-CE format to report CSI, one MAC-CE format to report HACK ACK/NACK, and one MAC-CE format to report both HARQ ACK/NACK and CSI. The WTRU may be configured with a second-TB-based retransmission (e.g., new-TB-based retransmission) enabled for these MAC-CEs. The WTRU may (e.g., may then) trigger a second-TB-based retransmission (e.g., new-TB-based retransmission) for these MAC-CEs. The WTRU may start a timer after initial transmission of the MAC-CE. The WTRU may (e.g., may then) trigger a second-TB-based retransmission (e.g., new-TB-based retransmission) for the MAC-CE if the timer has expired. The initial value of the timer set as zero may be equivalent to trigger a second-TB-based retransmission (e.g., new-TB-based retransmission) for the control/data unit right after the initial transmission.

The WTRU may trigger a second-TB-based retransmission (e.g., new-TB-based retransmission) for a control/data unit based on the time elapse from the previous (e.g., initial) transmission of the control/data unit. For example, the WTRU may (e.g., may first) perform a transmission (e.g., initial transmission) of a control/data unit. The WTRU may (e.g., may then) trigger a second-TB-based retransmission (e.g., new-TB-based retransmission) for the control/data unit if the time elapse from the previous (e.g., initial) transmission is greater than a configured threshold. For implementation, the WTRU may be configured with a timer (e.g., retransmission timer) for each control/data unit. The timer may be configured per QoS treatment profile (e.g., per RB/LCH). The WTRU may (e.g., may then) start the timer when the control/data unit is initially transmitted. The WTRU may (e.g., may then) trigger a second-TB-based retransmission (e.g., new-TB-based retransmission) for the control/data unit when the timer expires.

The WTRU may trigger a second-TB-based retransmission (e.g., new-TB-based retransmission) for a control/data unit based on the amount (e.g., relative amount) of discarded control/data units in the TB. For example, the WTRU may trigger a second-TB-based retransmission (e.g., new-TB-based retransmission) for the control/data units in the TB if the amount (e.g., relative amount) of discarded control/data in the TB is larger than a configured threshold. This may allow the WTRU to stop the on-going HARQ ID and multiplex the remaining control/data units to a second (e.g., new TB) as the original TB has many obsolete control/data units.

The WTRU may trigger a second-TB-based retransmission (e.g., new-TB-based retransmission) for a control/data unit based on the amount of delay-critical, high-importance/priority data in the TB. The WTRU may trigger a second-TB-based retransmission (e.g., new-TB-based retransmission) for the set of delay-critical, high-importance/priority control/data if the amount (e.g., relative amount) of the delay-critical, high-importance/priority control/data is larger than a configured threshold. This approach may stop the on-going HARQ ID and multiplex the delay-critical data in other TBs with more conservative transmission parameters.

The WTRU may perform a second-TB-based retransmission (e.g., new-TB-based retransmission) for a control/data unit based on the indication from the network and the QoS associated with the control/data unit. The WTRU may (e.g., may first) perform a transmission of the control/data unit in a TB. The WTRU may receive a report from the network indicating the NACK status associated with the TB, which may include the considered control/data unit. Such a report may be conveyed to the WTRU via a MAC-CE. The WTRU may (e.g., may then) trigger a second-TB-based retransmission (e.g., new-TB-based retransmission) for the control/data unit if the QoS associated with the control/data unit is satisfied. For example, the WTRU may trigger a second-TB-based retransmission (e.g., new-TB based retransmission) for the control/data unit if it is the delay-critical, and/or high importance/priority control/data unit.

The WTRU may trigger a second-TB-based retransmission (e.g., new-TB-based retransmission) based on the indication from the network and the amount (e.g., relative amount) of the discarded control/data units in the original TB. The WTRU may (e.g., may first) perform transmission of a control/data unit in a TB. The WTRU may (e.g., may then) receive NACK feedback for the TB. The WTRU may (e.g., may then) trigger a second-TB-based retransmission (e.g., new-TB-based retransmission) for the control/data unit if the amount (e.g., relative amount) of discarded control/data unit in the TB is larger than a configured threshold.

Examples of Transport Block (TB) reconstruction are provided herein. The WTRU may (e.g., may first) perform one or more transmissions (e.g., one initial transmission, one transmission and one retransmission) of a TB. The WTRU may not receive the reception status of the TB within a duration, or the network may fail to decode the TB. The WTRU may (e.g., may then) reconstruct the TB (e.g., performing TB reconstruction) to transmit in a scheduled grant. This approach may be motivated to increase the transmission reliability of the control/data unit in the reconstructed TB(s). The WTRU may perform MAC-based TB reconstruction or PHY-based TB reconstruction for TB reconstruction.

For MAC-based TB reconstruction, the WTRU may select one or more control/data units in the TB to construct one or more a TBs (e.g., new TBs) and retransmit the reconstructed TB(s). Such control/data units may be stored in a buffer (e.g., RLC buffer, HARQ MAC buffer, HARQ buffer) for retransmission purpose. A second constructed TB (e.g., a newly constructed TB) may include the control/data units from the original TB (e.g., only from the original TB). A second constructed TB (e.g., a newly constructed TB) may (e.g., may also) include control/data units not originated from the other original TB. For example, the second constructed TB (e.g., a newly constructed TB) may include the control/data units from other TBs and/or control/data units for initial transmission.

For PHY-based TB reconstruction, the WTRU may segment the original TB to multiple sub-TBs with smaller TB sizes. The WTRU may (e.g., may then) retransmit one or more constructed TBs (e.g., newly constructed TBs).

For the original TB, in examples, the WTRU may keep the original TB and retransmit the original TB in a future scheduled grant. In examples, the WTRU may discard the original TB and use the HARQ ID associated with the original TB to perform TB reconstruction. The WTRU may discard the original TB by flushing the HARQ buffer associated with the TB.

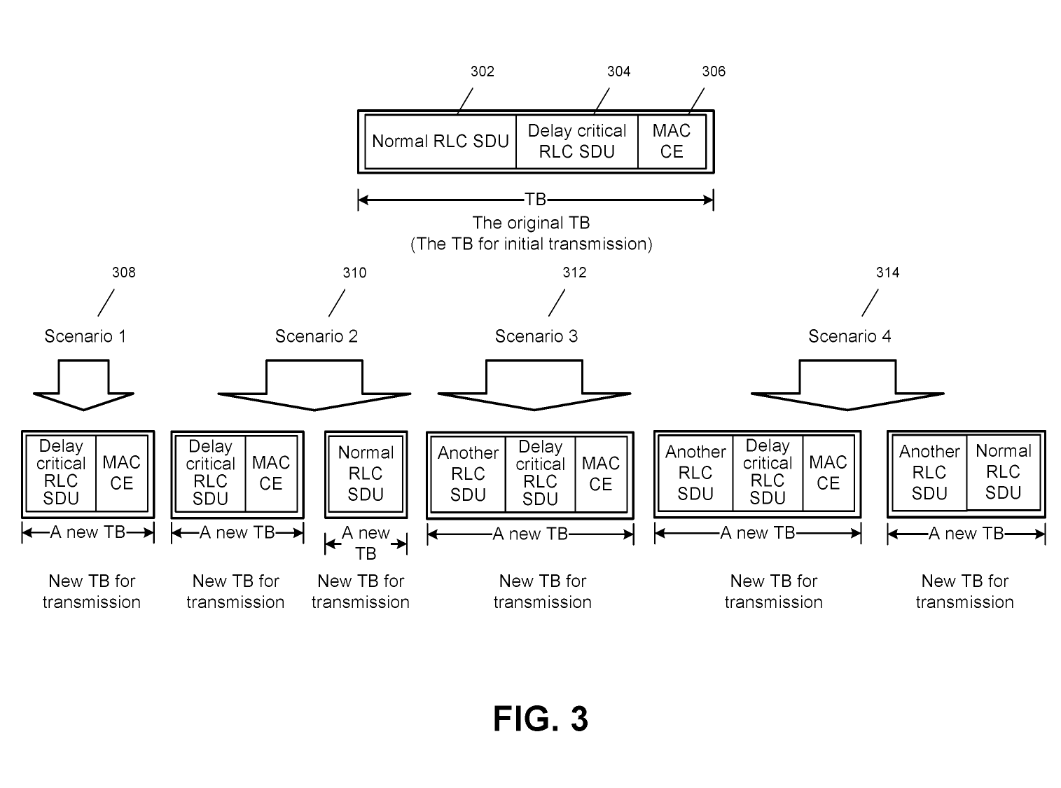

FIG. 3 illustrates an example of a WTRU selecting control/data unit(s) in an original TB to retransmit. As shown in FIG. 3, the WTRU may perform MAC-based TB reconstruction. The WTRU may (e.g., may first) transmit a TB (e.g., an original TB) for initial transmission of the control/data units in the TB. The original TB may include one normal RLC SDU 302, one delay-critical RLC SDU 304, and one MAC-CE 306. The WTRU may (e.g., may then) select one or more control/data units in the original TB to construct one or more TB(s) (e.g., new TB(s)) and retransmit the constructed TB(s) (e.g., newly constructed TB(s)). In a first example (Scenario 1 at 308 in FIG. 3), the WTRU may retransmit a subset of the original TB by constructing a second TB (e.g., new TB), which may include the delay critical RLC SDU and MAC-CE. In this example, the WTRU may discard the normal RLC SDU. In a second example (Scenario 2 at 310 in FIG. 3), the WTRU may construct two TBs (e.g., new TBs) from the original TB for retransmission. The first TB may include the delay-critical RLC SDU and one MAC-CE. The second TB may include the normal RLC SDU. In a third example (Scenario 3 at 312 in FIG. 3), the WTRU may construct a second TB (e.g., new TB) for retransmission, in which the second TB (e.g., new TB) may include the control/data unit from the original TB and other control/data unit(s). The other control/data unit may be originated from other TBs for retransmission and/or control/data units (e.g., new control/data units) for initial transmission. In the final example (Scenario 4 at 314 in FIG. 3), the WTRU may construct two TBs (e.g., new TBs) for (re)transmission. The first TB (e.g., new TB) may include MAC-CE, delay-critical RLC SDU, and other control/data unit(s). The second TB (e.g., new TB) may include the normal RLC SDU from the original TB and other control/data unit(s). The other control/data unit in the two TBs (e.g., new TBs) may be from other original TB or a control/data units (e.g., new control/data units) for initial transmission.

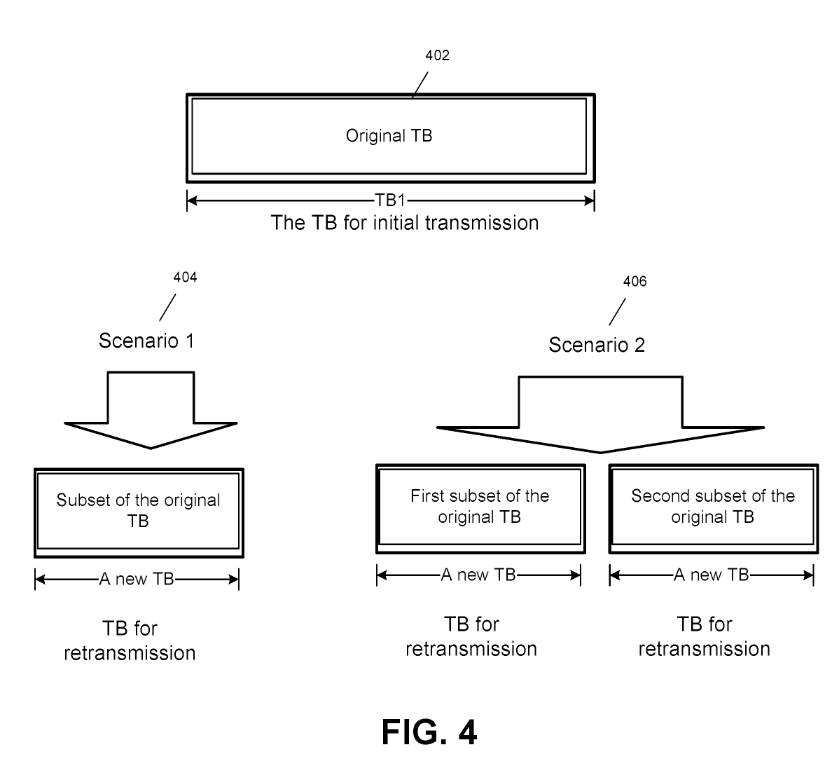

FIG. 4 illustrates an example of a WTRU segmenting the original TBs to multiple smaller TBs and retransmitting the reconstructed sub-TBs (e.g., newly reconstructed sub-TBs). As shown in FIG. 4, the WTRU may perform PHY-based TB reconstruction. The WTRU may (e.g., may first) transmit a TB (e.g., an original TB) 402 for initial transmission of the control/data units in the TB. The WTRU may (e.g., may then) segment the original TB to multiple TBs with smaller TB sizes and retransmit the constructed TBs (e.g., newly constructed TB(s)). In a first example (Scenario 1 at 404 in FIG. 4), the WTRU may construct and retransmit one TB (e.g., new TB) from the original TB. The WTRU may discard the remaining part(s) of the original TB. In a second example (Scenario 2 at 406 in FIG. 4), the WTRU may segment the original TB into two TBs (e.g., new TBs) and retransmit both TBs (e.g., new TBs).

In examples, the WTRU may determine the TB size for TB reconstruction using the same solution as legacy (e.g., based on number of resource elements and MCS as indicated by the DCI). In examples, the WTRU may determine the TB size for TB reconstruction based on a TB size or amount of data that the WTRU indicated as retransmission buffer status reporting (RBSR) (e.g., as described herein) in a previous PUSCH transmission for the HARQ process. If the WTRU indicated more than one TB size in the RBSR, the WTRU may determine which TB size based on the DCI indicating the grant for TB reconstruction. For example, the WTRU may determine which TB size based on the set of bits of an NDI field that flipped since the last reception of a DCI for the HARQ process. The WTRU may (e.g., may also) determine whether to apply legacy solution or the above-described solution for the determination of TB size based on the DCI indicating the grant for TB reconstruction or based on higher-layer configuration (e.g., possibly on a HARQ process basis).

The WTRU may be configured with one or more triggering conditions to perform TB reconstruction for a TB (e.g., MAC-based TB reconstruction, PHY-based TB reconstruction). If the triggering condition is satisfied, the WTRU may (e.g., may then) construct one or more TB (e.g., new TBs) from the original TB and retransmit the constructed TBs (e.g., newly constructed TB(s)). The WTRU may be configured with at least one of the following triggering conditions to perform TB reconstruction for an original TB: an indication from the network; the number of (re)transmissions associated with the original TB; the QoS associated with the control/data unit; the QoS treatment profile associated with the control/data unit; a transmission power-related condition of the WTRU (e.g., the transmission power of the WTRU, the PHR, Pcmax); a channel-related condition of the WTRU (e.g., pathloss, RSRP, RSRQ, RSSI); the set of control/data unit in the TB; the amount (e.g., relative amount) of control/data subject for potential retransmission; the amount (e.g., relative amount) of discarded control/data in the TB; whether the segment is required for TB reconstruction; the size of the grant; or the TB size.

The WTRU may trigger TB reconstruction for an original TB based on the indication from the network. The WTRU may (e.g., may first) perform one or more transmissions of the TB. The WTRU may (e.g., may then) implicitly/explicitly receive an indication from the network (e.g., DCI) to reconstruct the TB (e.g., MAC-based TB reconstruction, PHY-based TB reconstruction). When receiving of the indication from the network, the WTRU may (e.g., may then) trigger TB reconstruction using either MAC-based or PHY-based TB reconstruction. The WTRU may determine whether to keep the original TB based on the indication from the network. In examples, the WTRU may keep the original TB and retransmit the original TB in a future scheduled grant. In examples, the WTRU may discard the original TB by flushing the HARQ buffer associated with the TB. The WTRU may use the HARQ ID associated with the original TB to retransmit one or more constructed TB(s) (e.g., newly constructed TB(s)). The WTRU may (e.g., may also) use other HARQ ID(s) to retransmit one or more constructed TB(s) (e.g., newly constructed TB(s)).

The WTRU may be configured with a DCI format for scheduling a grant for TB reconstruction transmission. The WTRU may be configured with a DCI format for uplink scheduling, in which the WTRU may be indicated in a bitfield of whether the grant is used for retransmission of a TB or transmission of a TB reconstruction. The WTRU may (e.g., may also) be indicated in a bitfield (e.g., the HARQ ID field) of which original TB to perform TB reconstruction. The WTRU may be indicated whether to keep or flush the original TB. Such indication may be conveyed by a bitfield in the DCI (e.g., NDI field), in which one codepoint may indicate the WTRU to keep the original TB and another codepoint may indicate the WTRU to flush the original TB. The WTRU may be indicated of which HARQ ID to use for transmission of one or more constructed TBs (e.g., newly constructed TBs). If the WTRU is indicated to flush the original TB, the WTRU may (e.g., may then) flush the original TB and use the same HARQ ID associated with the original TB for TB reconstruction. If the WTRU is indicated to keep the original TB, the WTRU may keep using the original HARQ ID for retransmission of the original TB. In examples, the WTRU may be configured with a mapping of a HARQ ID for original TB and HARQ ID(s) for TB reconstruction. The WTRU may (e.g., may then) determine which HARQ ID(s) to use for TB reconstruction based on the HARQ ID associated with the original TB. In examples, the WTRU may be indicated in the DCI of which HARQ ID(s) to use for TB reconstruction. The WTRU may (e.g., may then) use the indicated HARQ ID(s) for TB reconstruction.

The WTRU may determine whether to perform TB reconstruction for a TB based on the HARQ ID associated with the TB. The WTRU may be configured with two set of HARQ IDs, in which the first set may be associated with TB reconstruction enabled, and another set may be associated with TB reconstruction disabled. The WTRU may (e.g., may then) determine to perform TB reconstruction if the HARQ ID of the TB belong to the first set of HARQ IDs (e.g., TB reconstruction enabled). The WTRU may (e.g., may then) determine not to perform TB reconstruction if the HARQ ID of the TB belongs to the second set of HARQ IDs (e.g., TB reconstruction disabled).

The WTRU may trigger TB reconstruction for an original TB based on the number of transmissions associated with the TB. The WTRU may perform TB reconstruction for the original TB if the number of (re)transmissions associated with the TB is greater than a configured threshold. The WTRU may be configured with a maximum number of transmissions for control/data units (e.g., each control/data unit) in a TB, which may be associated with the QoS treatment profile of the control/data unit (e.g., the RB/LCH/PDU-set associated with the control/data unit). The WTRU may (e.g., may then) perform TB reconstruction for the TB if the number of transmissions for a control/data unit in the TB is greater than the configured threshold associated with the control/data unit.

The WTRU may trigger TB reconstruction for a TB based on the QoS associated with the TB. In examples, WTRU may perform TB reconstruction for a TB if the delay budget (e.g., remaining delay budget) of one or more control/data units in the TB is smaller than a configured threshold. In examples, the WTRU may perform TB reconstruction for a TB if the priority associated with one or more control/data units in the TB is greater than a configured threshold. In examples, the WTRU may perform TB reconstruction for a TB if the importance associated with one or more control/data units in the TB is greater than a configured threshold.

The WTRU may perform TB reconstruction for a TB based on the QoS treatment profile associated with the control/data units multiplexed in the TB. The WTRU may be configured with TB reconstruction enabled/disabled for QoS treatment profiles (e.g., each QoS treatment profile). The WTRU may (e.g., may then) determine to perform TB reconstruction for a TB if it has one or more control/data units associated with TB reconstruction enabled. If all the control/data unit multiplexed in the TB is associated with TB reconstruction disabled, the WTRU may determine not to perform TB reconstruction for the TB.

The WTRU may be configured with TB reconstruction enabled/disabled for each RB/LCH/PDU-set. The WTRU may (e.g., may then) determine to perform TB reconstruction for a TB if it has one or more control/data units associated with TB reconstruction enabled RB/LCH/PDU-set. If all the control/data units multiplexed in the TB are associated with TB reconstruction disabled RB/LCH/PDU-set, the WTRU may not perform TB reconstruction for the TB.

The WTRU may be configured with TB reconstruction enabled/disabled for each MAC-CE. The WTRU may (e.g., may then) determine to perform TB reconstruction for a TB if it has one or more MAC-CEs with TB reconstruction enabled.

The WTRU may trigger TB reconstruction for a TB based on transmission power-related condition. The WTRU may (e.g., may first) be configured with a transmission power-related condition (e.g., a threshold) to perform TB reconstruction for a TB. The WTRU may (e.g., may then) perform TB reconstruction for the TB if the transmission power-related condition is satisfied. Otherwise, the WTRU may determine to retransmit the original TB (e.g., without performing TB reconstruction). The WTRU may be configured with one or more of the following transmission power-related conditions: the transmission power of the WTRU, the PHR of the WTRU, the change in the transmission power of the WTRU compared to a previous transmission (e.g., the transmission of the original TB); or the PHR difference compared to a previous PHR.

For the transmission power of the WTRU, the WTRU may perform TB reconstruction for the TB if the transmission power of the WTRU is larger/smaller than a configured threshold.

For the PHR of the WTRU, the WTRU may perform TB reconstruction for the TB if the PHR of the WTRU is larger/smaller than a configured threshold. Otherwise, the WTRU may perform original TB retransmission. For example, the WTRU may perform TB reconstruction for the TB if it has negative PHR for the retransmission. If the WTRU has positive PHR for retransmission, the WTRU may perform original TB retransmission.

For the change in the transmission power of the WTRU compared to a previous transmission (e.g., the transmission of the original TB), the WTRU may perform TB reconstruction for the TB if the change in the transmission power of the WTRU compared to the previous transmission (e.g., the initial transmission of the TB) is larger/smaller than a configured threshold.

For the PHR difference compared to a previous PHR, the WTRU may perform TB reconstruction for the TB if the change in PHR compared to the previous transmission of the TB is greater/smaller than a configured threshold.

The WTRU may trigger TB reconstruction for a TB based on a channel-related condition. The WTRU may (e.g., may be first) configured with a channel-related condition (e.g., a threshold) to perform TB reconstruction for a TB. The WTRU may (e.g., may then) perform TB reconstruction for a TB if the channel-related condition is satisfied. Otherwise, the WTRU may transmit the original TB. The WTRU may be configured with at least one of the following channel-related conditions: the measured pathloss, the channel measurement (e.g., RSRP, RSSI, RSRQ), the change in the pathloss, or the change in the channel measurement.

For the measured pathloss, the WTRU may perform TB reconstruction for the TB if the measured pathloss of the WTRU is larger/smaller than a configured threshold.

For the channel measurement (e.g., RSRP, RSSI, RSRQ), the WTRU may perform TB reconstruction for the TB if Uu RSRP is larger/smaller than a configured threshold.

For the change in the pathloss, the WTRU may perform TB reconstruction for the TB if the change in the measured pathloss of the WTRU is larger/smaller than a configured threshold.

For the change in the channel measurement, the WTRU may perform TB reconstruction for the TB if the change in Uu of the WTRU is larger/smaller than a configured threshold.

The WTRU may trigger TB reconstruction for a TB based on the amount (e.g., relative amount) of control/data in the original TB subject for potential retransmission. The WTRU may be configured with a condition for a control/data unit to be retransmitted if the TB is reconstructed. The WTRU may (e.g., may then) determine the (relative) amount of control/data satisfying the retransmission condition in TB reconstruction. If the (relative) amount of the control/data for retransmission in TB reconstruction is smaller/larger than a configured threshold, the WTRU may perform TB reconstruction. For example, if the (relative) amount of importance control/data is smaller than a configured threshold, the WTRU may perform TB reconstruction. For example, if the (relative) amount of delay-critical control/data is smaller/larger than a configured threshold, the WTRU may perform TB reconstruction. This approach may be motivated to guarantee the reliability of the transmission associated with TB reconstruction as the WTRU may be able to reduce significantly the TB size of the reconstruction.

The WTRU may trigger TB reconstruction for a TB based on the amount (e.g., relative amount) of control/data in the original TB subject for discarding. The WTRU may be configured with a condition for a control/data unit to be discarded if the TB is reconstructed. The WTRU may (e.g., may then) determine the (relative) amount of control/data satisfying the discard condition in TB reconstruction. If the (relative) amount of the control/data for discarding in TB reconstruction is smaller/larger than a configured threshold, the WTRU may perform TB reconstruction. For example, if the (relative) amount of obsolete/outdated control/data is larger than a configured threshold, the WTRU may perform TB reconstruction. This approach may be motivated to increase the reliability of the constructed TB (e.g., newly constructed TB).

The WTRU may determine whether to perform TB reconstruction based on whether segmentation is required for one or more control/data unit. The WTRU may perform TB reconstruction if segmentation is not required for a control/data unit. For example, the WTRU may have a control/data unit subject for retransmission in TB reconstruction. The WTRU may (e.g., may then) perform TB reconstruction if segmentation is not required for the control/data unit.

The WTRU may determine whether to perform TB reconstruction based on the size (e.g., relative size) of the grant. The WTRU may be scheduled a grant for transmission of the TB. If the (relative) size of the grant compared to the original TB size is larger/smaller than a configured threshold, the WTRU may perform TB reconstruction. Otherwise, the WTRU may not perform TB reconstruction.

The WTRU may determine whether to perform TB reconstruction based on the TB size. If the TB size is larger than a configured threshold, the WTRU may perform TB reconstruction. If the TB size is larger than the threshold, the WTRU may not perform TB reconstruction.

The WTRU may perform TB reconstruction for an original TB based on the indication from the network and the amount (e.g., relative amount) of delay-critical control/data in the original TB. The WTRU may (e.g., may first) transmit a TB. The WTRU may (e.g., may then) receive a grant for potential TB reconstruction transmission of the original TB. The WTRU may (e.g., may then) determine whether to perform TB reconstruction for transmission in the grant based on the amount (e.g., relative amount) of delay critical control/data in the TB. If the (relative) amount of delay-critical control/data in the TB is larger/smaller than a configured threshold, the WTRU may perform TB reconstruction transmission. Otherwise, the WTRU may transmit the same original TB. The WTRU may (e.g., may then) indicate such a decision in an UCI associated with the transmission to inform the network whether the WTRU is performing TB reconstruction or not for the transmission.

The WTRU may perform TB reconstruction for an original TB based on the indication from the network and the amount (e.g., relative amount) of discarded control/data in the original TB. The WTRU may (e.g., may first) transmit a TB. The WTRU may (e.g., may then) receive a grant for potential TB reconstruction transmission of the original TB. The WTRU may (e.g., may then) determine whether to perform TB reconstruction for transmission in the grant based on the (relative) amount of discarded control/data in the TB. If the (relative) amount of discarded control/data in the TB is larger/smaller than a configured threshold, the WTRU may perform TB reconstruction transmission. Otherwise, the WTRU may transmit the same original TB. The WTRU may (e.g., may then) indicate such decision in an UCI associated with the transmission to inform the network whether it is performing TB reconstruction or not for the transmission.

The WTRU may determine whether to discard a TB. If discarding a TB, the WTRU may (e.g., may then) flush the HARQ buffer with HARQ ID associated with the TB. Such a decision may be performed when performing TB reconstruction. The WTRU may determine whether to discard a TB based on one or more of the following: an indication from the network, the time elapsed associated with the TB, the number of transmissions associated with the TB, the amount (e.g., relative amount) of discarded control/data multiplexed in the TB being larger than a configured threshold, or all the control/data units (e.g., unobsolete control/data units) in the TB being multiplexed in another TB or are being triggered to be multiplexed in another TB for retransmission.

For the indication from the network, the WTRU may implicitly/explicitly indicate the WTRU to reconstruct the TB and discard the original TB. Such an indication may be received via a DCI scheduling a resource for transmission of TB reconstruction. The WTRU may (e.g., may then) reconstruct the TB and discard the original TB.

For the time elapsed associated with the TB, the WTRU may (e.g., may first) construct a TB for initial transmission and potential HARQ-based retransmission. The WTRU may discard the TB if the time has elapsed for at least a configured duration. For example, the WTRU may start a discardTimer for a TB if the TB is constructed/transmitted. The WTRU may (e.g., may then) discard the TB if the discardTimer expires. The initial value of the discardTimer may be configured per QoS treatment of a control/data unit, and/or per RB/LCH/PDU-set.

For the number of transmissions associated with the TB, the WTRU may discard the TB if the number of transmissions associated with the TB is larger than a configured threshold. The number of transmissions threshold may be configured per QoS treatment of a control/data unit and/or per RB/LCH/PDU-set.

For the amount (e.g., relative amount) of discarded control/data multiplexed in the TB being larger than a configured threshold, the WTRU may discard the TB if the control data units (e.g., all the control/data unit) multiplexed in the TB are discarded. The WTRU may be configured with a duration threshold for the control/data units (e.g., each control/data unit) in the TB. The WTRU may (e.g., may then) discard the control/data if it stays in the buffer of the WTRU for a duration being greater than the configured threshold. The WTRU may (e.g., may then) discard the TB if the control/data units (e.g., all the control/data units) in the TB are obsoleted/outdated.

For all the control/data units (e.g., unobsolete control/data units) in the TB being multiplexed in another TB or being triggered to be multiplexed in another TB for retransmission, the WTRU may (e.g., may also) multiplex one or more control/data unit in the TB in a second TB (e.g., new TB) for retransmission in a different TB (e.g., after transmission of the TB). The WTRU may (e.g., may then) discard the TB if all the unobsolete control/data units in the TB are triggered to be multiplexed in another TB for transmission. For example, the WTRU may reconstruct the TB by selecting a set of control/data units of the TB to multiplex in a second TB (e.g., new TB) for transmission. The WTRU may (e.g., may then) discard the TB if all the unobsolete control/data units in the TB are included in the second TB (e.g., new TB).

Examples for selecting/prioritizing control/data for multiplexing are provided herein. The WTRU may be configured with multiple multiplexing procedures (e.g., LCP procedure) to multiplex the set of control/data units in a TB for transmission in a scheduled grant. The multiplexing procedure may include one or more of the following: the associated parameters for the multiplexing procedure; or which sets of control/data units to consider/prioritize for multiplexing in the TB.

For the associated parameters for the multiplexing procedure, the multiplexing procedure may be used for the WTRU to fill the bucket of a QoS treatment profile (e.g., RB/LCH) with the rate of b + PBR*T. PBR may be the prioritized bit rate (PBR) associated with the QoS treatment profile (e.g., RB/LCH). b may be the initial value of the bucket size. T may be the time elapse for serving the QoS treatment profile ID (e.g., RB/LCH). For example, the WTRU may be configured with multiple multiplexing procedures, in which each procedure may be associated with one set of parameters (e.g., relative priority of each QoS treatment profile (e.g., RB/LCH), the PBR, and the initial value of the bucket b).

For which sets of control/data units to consider/prioritize for multiplexing in the TB, the WTRU may be configured with a multiplexing procedure considering/prioritizing the control/data units subject for a second-TB-based retransmission (e.g., new-TB-based retransmission). For example, the WTRU may be configured with a multiplexing procedure considering/prioritizing control/data unit subject for initial transmission. For example, the WTRU may be configured with a multiplexing procedure prioritizing the one set of control/data units (e.g., feedback-based, status-report-based new-TB-based retransmission) subject for the second-TB-based retransmission (e.g., new-TB-based retransmission) over an initial transmission and/or prioritize an initial transmission over another set of control/data units subject for a TB-based retransmission (e.g., WTRU autonomous-based new-TB-based retransmission).

For which sets of control/data units to consider/prioritize for multiplexing in the TB, the WTRU may be configured with a multiplexing procedure considering/prioritizing the control/data units from an original TB (e.g., multiplexing procedure for TB reconstruction). The WTRU may be configured with one multiplexing procedure, which may consider the control/data units from one TB only. The WTRU may be configured with another multiplexing procedure, which may prioritize the control/data units from the original TB. If there are more resources, the WTRU may multiplex other control/data units.

The WTRU may (e.g., may then) determine which multiplexing procedure to use for a scheduled grant based on one or more of the following: an implicit/explicit indication from the network; or which type of TB to be transmitted in the scheduled grant.

For the implicit/explicit indication from the network, the WTRU may be configured with multiple multiplexing procedures IDs in RRC. The WTRU may be scheduled with a grant for uplink transmission. The WTRU may (e.g., may also) be implicitly/explicitly indicated (e.g., in DCI) which multiplexing procedure ID to construct the TB for transmission in the scheduled grant. The WTRU may (e.g., may then) use the indicated multiplexing procedure ID to construct the TB and transmit in the scheduled grant.

For the implicit/explicit indication from the network, the WTRU may be configured with a multiplexing procedure ID for initial transmission of a TB to support TB reconstruction transmission. The WTRU may (e.g., may then) receive an indication from the network whether to perform the indicated multiplexing procedure ID to support TB reconstruction transmission. Such an indication may be received via DCI. Such an indication may be received via an HARQ ID. The WTRU may be configured with a set of HARQ ID with TB reconstruction enabled. The WTRU may (e.g., may then) perform the associated multiplexing procedure ID if the WTRU is indicated the HARQ ID with TB reconstruction enabled.

For the implicit/explicit indication from the network, an indication from the network may include an extended N-bit NDI field. The WTRU may perform a normal HARQ retransmission under a condition that all bits of the N-bits NDI field are the same as the previously received DCI for the HARQ process. Otherwise, the WTRU may flush the HARQ entity and perform TB reconstruction using a multiplexing procedure and/or parameters according to the set of bits of the NDI field that are not the same (e.g., flipped) as the previously received DCI for the HARQ process. For example, if the WTRU receives NDI with a first set of bits that flipped, the WTRU may perform TB reconstruction for the set of control/data units with the highest priority level (e.g., the highest priority level only). If the WTRU receives NDI with a second set of bits that flipped, the WTRU may perform TB reconstruction for the set of control/data units with the two highest priority levels (e.g., the two highest priority levels only). If the WTRU receives NDI with a third set of bits that flipped, the WTRU may perform TB reconstruction for the set of control/data units including MAC CE(s) (e.g., including MAC CEs only). If the WTRU receives NDI with a fourth set of bits that flipped, the WTRU may perform transmission of a TB for a set (e.g., new set) of control/data units (e.g., as per legacy). These examples may enable indication of 2N-1 multiplexing procedures and/or parameters for TB construction or reconstruction.

For which type of TB to be transmitted in the scheduled grant, the WTRU may be configured with one or multiple multiplexing procedures IDs for TBs (e.g., each type of TB) to be transmitted in a scheduled grant. The WTRU may (e.g., may then) determine which multiplexing procedure (e.g., LCP) to use based on the type of TB to be transmitted in the scheduled grant. For example, the WTRU may be configured with one or multiple multiplexing procedures (e.g., LCP) for TB reconstruction. The WTRU may be configured with one or more multiplexing procedures for a second TB transmission (e.g., new TB transmission). The WTRU may (e.g., may then) determine which multiplexing procedure to use based on whether the WTRU is using the grant for a second TB transmission (e.g., new TB transmission) or for a TB reconstruction transmission.

The WTRU may determine the priority associated with control/data units (e.g., each control/data unit), which may be used to determine the priority order of the control/data units to multiplex in a TB for transmission. The priority of the control/data units (e.g., each control/data unit) may be determined based on one or more of the following: an implicit/explicit indication/configuration from the network, the QoS and/or QoS treatment associated with the control/data unit, whether the control/data unit is associated with the initial transmission or a second-TB based (e.g., new-TB based) retransmission, the trigger for a second-TB-based retransmission (e.g., new-TB-based retransmission) associated with the control/data unit if it is subject for second-TB-based (e.g., new-TB-based) retransmission; or whether the unit is the control unit or the data unit.

For the implicit/explicit indication/configuration from the network, the WTRU may receive an indication from the network (e.g., in a DCI scheduling the grant, in a MAC-CE to activate a configured grant, in an RRC message to configure a configured grant) of which control/data unit(s) to be prioritized in the scheduled grant. The WTRU may (e.g., may then) prioritize the indicated control/data unit(s) to multiplex in a TB for transmission in the scheduled grant. For the implicit/explicit indication/configuration from the network, the WTRU may be indicated to perform TB reconstruction transmission of a TB in a scheduled grant. The WTRU may (e.g., may then) prioritize the control/data unit(s) of the indicated TB. For example, the WTRU may be indicated to prioritize the second-TB-based retransmission (e.g., new-TB-based retransmission) control/data unit(s). The WTRU may (e.g., may then) prioritize the TB-based retransmission (e.g., new-TB-based retransmission) control/data unit(s) for a second-TB-based retransmission (e.g., new-TB-based retransmission) to multiplex in a TB for transmission in the scheduled grant. For example, the WTRU may be indicated to prioritize the control/data unit(s) associated with initial transmission. The WTRU may (e.g., may then) prioritize the control/data unit(s) for initial transmission to multiplex in a TB for transmission in the scheduled grant. For the implicit/explicit indication/configuration from the network, the WTRU may be configured with priority (e.g., relative priority) among control and data units. The WTRU may (e.g., may then) use the configured priority (e.g., relative priority) of the control/data units to determine which control/data units are prioritized during a multiplexing procedure.

For the QoS and/or the QoS treatment associated with the control/data unit, the WTRU may prioritize the control/data unit based on the delay budget (e.g., remaining delay budget) associated with the control/data unit. For example, the WTRU may prioritize the control/data unit based on the priority associated with the control/data unit. For example, for TB reconstruction, the WTRU may prioritize the control/data unit with based on one or more of: the lowest delay budget (e.g., lowest remaining delay budget), highest priority, or highest importance to multiplex in a TB for transmission. For the QoS and/or the QoS treatment associated with the control/data unit, the WTRU may prioritize control units (e.g., a MAC-CE) based on the configured/fixed priority (e.g., relative priority) associated with the control unit.

For whether the control/data unit is associated with the initial transmission or a second-TB-based (e.g., new-TB-based) retransmission, for the control/data unit associated with the same QoS treatment profile (e.g., the same RB/LCH), the WTRU may prioritize initial transmission over second-TB-based (e.g., new-TB-based) retransmission in one set of conditions. The WTRU may prioritize a second-TB-based (e.g., new-TB-based) retransmission over initial transmission in another set of conditions. The conditions may be associated with the trigger condition for a second-TB-based (e.g., new-TB-based) retransmission.

For whether the control/data unit is associated with the initial transmission or a second-TB-based (e.g., new-TB-based) retransmission, the WTRU may be configured to prioritize the second-TB-based (e.g., new-TB-based) retransmission over an initial transmission of control/data units, which may be associated with the same QoS treatment profile (e.g., same RB/LCH). Such prioritization may be associated with the retransmission control/data unit having NACK feedback from the network. The WTRU may (e.g., may first) trigger a second-TB-based (e.g., new-TB-based) retransmission for a data/control unit based on the NACK feedback from the network. In examples, the WTRU may (e.g., may then) prioritize the retransmission control/data unit over an initial control/data unit of the same QoS treatment profile (e.g., of the same RB/LCH). In examples, the WTRU may be configured to prioritize the initial transmission over a second-TB-based (e.g., new-TB-based) retransmission of control/data unit from the same QoS treatment profile. Such prioritization may be associated with the autonomous retransmission control/data unit. The WTRU may (e.g., may only) opportunistically transmit and perform autonomous retransmission of the control/data unit if the control/data unit for initial transmission is prioritized.

For the triggering for a second-TB-based (e.g., new-TB-based) retransmission associated with the control/data unit if it is subject for the second-TB-based (e.g., new-TB-based) retransmission, the WTRU may be configured to prioritize the control/data units associated with feedback-based/status-report-based second-TB-based (e.g., new-TB-based) retransmission over control/data unit subject for initial transmission. For the triggering for a second-TB-based (e.g., new-TB-based) retransmission associated with the control/data unit if it is subject for the second-TB-based (e.g., new-TB-based) retransmission, the WTRU may prioritize control/data units subject for initial transmission over the control/data units subject for WTRU-autonomous-based retransmission.

For whether the unit is a control unit or data unit, the WTRU may be configured to prioritize a control unit over a data unit. For this configuration, the WTRU may prioritize MAC-CE over RLC SDUs (e.g., where the MAC CE may be prioritized to be multiplexed in the second TB over a retransmitted RLC SDU). For whether the unit is a control unit or data unit, the WTRU may prioritize a data unit if the delay budget (e.g., remaining delay budget) associated with the data unit is smaller than a threshold. Otherwise, the WTRU may prioritize a control unit. For example, if the delay budget (e.g., remaining delay budget) of a RLC SDU is smaller than a configured threshold, the WTRU may prioritize a data RLC SDU over a MAC-CE and/or control RLC SDU. Otherwise, the WTRU may prioritize the MAC-CE and/or the control RLC SDU over the data RLC SDU.

The WTRU may be scheduled with an uplink grant. The WTRU may have one or more TBs subject to reconstruction. The WTRU may (e.g., may also) have data/control subject for multiplexing in a TB for (re)transmission. The control/data unit may be associated with a second-TB-based (e.g., new-TB-based) retransmission and/or initial transmission. The WTRU may (e.g., may then) determine whether the grant is used for TB reconstruction transmission or initial transmission of a second TB (e.g., new TB). Such a determination may be based on one or more of the following: an indication from the network; a configured priority (e.g., relative priority) associated with TB reconstruction transmission; the QoS (e.g., the delay budget (e.g., remaining delay budget), the priority, the QoS treatment profile) associated with the second TB (e.g., new TB) transmission and/or the QoS associated with the TB subject to reconstruction; or the configured precedence of one type of transmission.

For the indication from the network, the WTRU may be indicated by the network (e.g., via DCI scheduling) whether the grant is used for TB reconstruction transmission or a second-TB-based (e.g., new-TB-based) transmission. The WTRU may (e.g., may then) determine the indicated type of transmission in the scheduled resource.

For the configured priority (e.g., relative priority) associated with TB reconstruction transmission, in examples, the WTRU may be configured to prioritize (e.g., always prioritize) TB reconstruction transmission over a second TB transmission (e.g., new TB transmission). The WTRU may (e.g., may then) prioritize TB reconstruction transmission in the scheduled grant. In examples, the WTRU may be configured to prioritize (e.g., always prioritize) a second TB (e.g., new TB) over TB reconstruction transmission. The WTRU may (e.g., may then) prioritize a second TB transmission (e.g., new TB transmission) in the scheduled grant.

For the QoS (e.g., the delay budget (e.g., remaining delay budget), the priority, the QoS treatment profile) associated with the second TB transmission (e.g., new TB transmission) and/or the QoS associated with the TB subject to reconstruction, in examples, the WTRU may determine which transmission (e.g., TB reconstruction transmission vs. a second TB transmission) to prioritize to be transmitted in the grant based on the delay (e.g., remaining delay) associated with each transmission. The WTRU may prioritize TB reconstruction if it includes the data/control unit with the lowest delay budget (e.g., lowest remaining delay budget) among the data/control units of the TB construction and a second TB transmission (e.g., new TB transmission). Otherwise, the WTRU may prioritize a second TB transmission (e.g., new TB transmission). In examples, the WTRU may determine which transmission to prioritize based on the priority associated with each transmission. The WTRU may prioritize TB reconstruction transmission if it includes the data/control unit with the highest priority. Otherwise, the WTRU may prioritize a second TB transmission (e.g., new TB transmission).

For the configured precedence of one type of transmission, in examples, the WTRU may prioritize TB reconstruction retransmission over a second TB transmission (e.g., new TB transmission). If the grant satisfies other condition(s), the WTRU may (e.g., may then) perform TB reconstruction retransmission. In examples, the WTRU may prioritize a second TB retransmission (e.g., new TB retransmission) over TB reconstruction retransmission. For the configured precedence of one type of transmission, the WTRU may prioritize TB reconstruction if the QoS associated with the TB reconstruction satisfies a configured condition. In examples, the WTRU may prioritize TB reconstruction if the delay budget (e.g., remaining delay budget) associated with the TB is smaller than a configured threshold. In examples, the WTRU may prioritize TB reconstruction if the priority associated with the TB is larger than a configured threshold. For the configured precedence of one type of transmission, the WTRU may prioritize a second TB transmission (e.g., new TB transmission) if the QoS associated with the second TB transmission (e.g., new TB transmission) satisfies a configured condition. For example, the WTRU may prioritize a second TB transmission (e.g., new TB transmission) if the delay budget (e.g., remaining delay budget) associated with the TB is smaller than a configured threshold. For example, the WTRU may prioritize a second TB transmission (e.g., new TB transmission) if the priority associated with the TB is larger than a configured threshold.

The WTRU may have multiple TBs subject for TB reconstruction transmission. The WTRU may (e.g., may then) be scheduled a grant, which may be used for TB reconstruction transmission. The WTRU may (e.g., may then) determine which TB to perform (e.g., to prioritize for) TB reconstruction transmission based on one or more of the following: an indication from network, the QoS associated with the TB, the time associated with the TB reconstruction trigger, or the transmission time associated with the first or last transmission of the TB.

For the indication from network, the network may indicate which HARQ ID is used for TB reconstruction transmission of the grant. The WTRU may (e.g., may then) reconstruct the indicated TB and transmit the TB in the scheduled grant from the network.

For the QoS associated with the TB, the WTRU may prioritize the TB with lowest delay budget (e.g., remaining lowest delay budget) to reconstruct and transmit in the scheduled grant. For example, the WTRU may prioritize the TB with highest priority to reconstruct and transmit in the scheduled grant.

For the time associated with TB reconstruction trigger, the WTRU may prioritize the first TB to trigger TB reconstruction and transmission. For example, the WTRU may prioritize the last TB to trigger TB reconstruction and transmission.

For the transmission time associated with the first or last transmission of the TB, the WTRU may prioritize the TB having the earliest initial transmission. For example, the WTRU may may prioritize the TB having the earliest last transmission before triggering TB reconstruction transmission.

The WTRU may determine to perform TB reconstruction and transmit the reconstructed TB in a scheduled grant. The WTRU may (e.g., may first) determine one or more of the following for its TB reconstruction and transmission: the HARQ ID associated with TB reconstruction transmission; the multiplexing (e.g., LCP) procedure (e.g., the WTRU may be configured with multiple multiplexing procedures for TB reconstruction and the WTRU may then determine to use one of the multiplexing procedures to construct a second TB (e.g., a new TB) for TB reconstruction transmission; the TB size; the MCS; the set of resources used for transmission; transmission power; a number of repetitions; or whether a certain parameter (e.g., which multiplexing procedure, TB size, MCS, the set of resources used for transmission) is selected by the WTRU and/or indicated by the network. In examples, the WTRU may be indicated to autonomously select the TB size for TB reconstruction retransmission. In examples, the WTRU may be indicated a TB size to reconstruct a second TB (e.g., a new TB). In examples, the WTRU may be indicated to select a MCS from a set of possible MCS values. In examples, the WTRU may be indicated the MCS to use for its transmission. In examples, the WTRU may be indicated to select resource sizes from a set of possible resource sizes. In examples, the WTRU may be indicated use a specific resource size for its transmission.

The WTRU may select the value of each parameter (e.g., multiplexing procedure, TB size, the MCS, the set of resources used for transmission, transmission power) from a limited set of values for each parameter. The selected set of values for each parameter may be indicated to the WTRU from the network (e.g., via DCI signaling, or RRC configuration). The WTRU may indicate the determined parameters to the network (e.g., based on the determination of the transmission parameters for the TB). Such an indication may be transmitted in a part of the scheduled resource for transmission of the TB. For example, the WTRU may transmit the indication in a UCI associated with the transmission of the TB. The exact value for each parameter may be determined (e.g., additionally) based on one or more of the following: an implicit/explicit indication (e.g., in DCI) from the network; the set of control/data units subject for retransmission in a reconstructed TB; the TB size (e.g., new TB size) for TB reconstruction transmission; or the QoS associated with the second TB (e.g., new TB).

For the implicit/explicit indication (e.g., in DCI) from the network, in examples regarding selection of the multiplexing procedure, the WTRU may be configured with multiple multiplexing procedures for a TB reconstruction transmission. The WTRU may receive an indication from the network of which multiplexing procedure to use (e.g., via DCI associated with the scheduled resource or an RRC configuration of the multiplexing procedure to use). The WTRU may (e.g., may then) use the indicated multiplexing procedure to construct the TB for TB reconstruction transmission.

For the implicit/explicit indication (e.g., in DCI) from the network, in examples regarding the selection of TB size selection, the WTRU may be implicitly/explicitly indicated which TB size to construct to transmit in a scheduled grant. The TB size may be determined based on a formular, which may be derived from at least the resource size and MCS indicated from the network.

For the set of control/data units subject for retransmission in a reconstructed TB, the WTRU may perform multiplexing procedure to reconstruct a second TB (e.g., a new TB) for TB reconstruction transmission. The WTRU may multiplex the control/data units (e.g., all the control/data units) satisfying the retransmission condition. The WTRU may discard the control/data units not satisfying the retransmission condition. For example, the WTRU may discard the obsolete control/data, which may be discarded by a higher layer (e.g., PDCP, RLC). The TB size of the second TB (e.g., the new TB) may be (e.g., may then be) determined based on the set of control/data units satisfying the retransmission condition.

For the TB size (e.g., new TB size) for TB reconstruction transmission, the WTRU may determine the MCS associated with the TB reconstruction transmission based on the TB size of the constructed TB (e.g. newly constructed TB).

For the QoS associated with the second TB (e.g., new TB), the WTRU may select the MCS for based on the QoS (e.g., priority) associated with the second TB (e.g., new TB). The WTRU may be configured with the possible MCS per priority. The WTRU may (e.g., may then) determine which MCS to use for TB reconstruction transmission based on the priority associated with the TB. For the QoS associated with the second TB (e.g., new TB), the WTRU may determine the number of repetitions for the TB based on the QoS (e.g., priority) associated with the TB. The WTRU may be configured with the number of repetitions as a function of the QoS (e.g., delay budget or remaining delay budget) for the TB. The WTRU may (e.g., may then) determine the number of repetitions for the TB based on the QoS of the second TB (e.g., new TB).

The WTRU may be configured to perform one or more of the following multiplexing procedure (e.g., LCP) for TB reconstruction transmission: an original-TB-only multiplexing procedure; or an original-TB-prioritized multiplexing procedure.

For the original-TB-only multiplexing procedure, for this multiplexing procedure, the WTRU may multiplex the control/data from the original TB to build a second TB (e.g., new TB) for TB reconstruction transmission.

For the original-TB-prioritized multiplexing procedure, for this multiplexing procedure, the WTRU may first prioritize the control/data units from the original TB. For example, the WTRU may prioritize the control/data units from the original TB satisfying the retransmission condition (e.g., delay-critical, high importance, high priority control/data units). The WTRU may (e.g., may then) multiplex the control/data for initial transmission and/or the control/data units for retransmission from the other TB.

The WTRU may perform original-TB-only multiplexing procedure for TB reconstruction, in which the WTRU may multiplex the control/data unit from the original TB only. If reconstruction of a TB is triggered, the WTRU may multiplex the control/data unit from the original TB in an order until the determined TB size and/or the control/data units (e.g., all the control/data units) in the original TB satisfying the retransmission criteria are multiplexed in a second TB (e.g., a new TB). The WTRU may perform zero-padding of the remaining resource if the remaining resource of the TB does not fit a control/data unit (e.g., a RLC SDU/PDU (segment)) and/or control/data units (e.g., all the control/data units) satisfying the retransmission criteria are multiplexed. This approach may be applicable if the TB size is determined by the network. This approach may be motivated to reduce segmentation of a control/data unit for TB reconstruction. In examples, the WTRU may (re)segment a control/data unit to fit to the scheduled resource. If the TB size is determined by the WTRU, the WTRU may multiplex the control/data unit to the second TB (e.g., new TB) until the control/data units (e.g., all the control/data units) of the TB subject for retransmission are multiplexed and/or the TB size reaches its indicated maximum size.

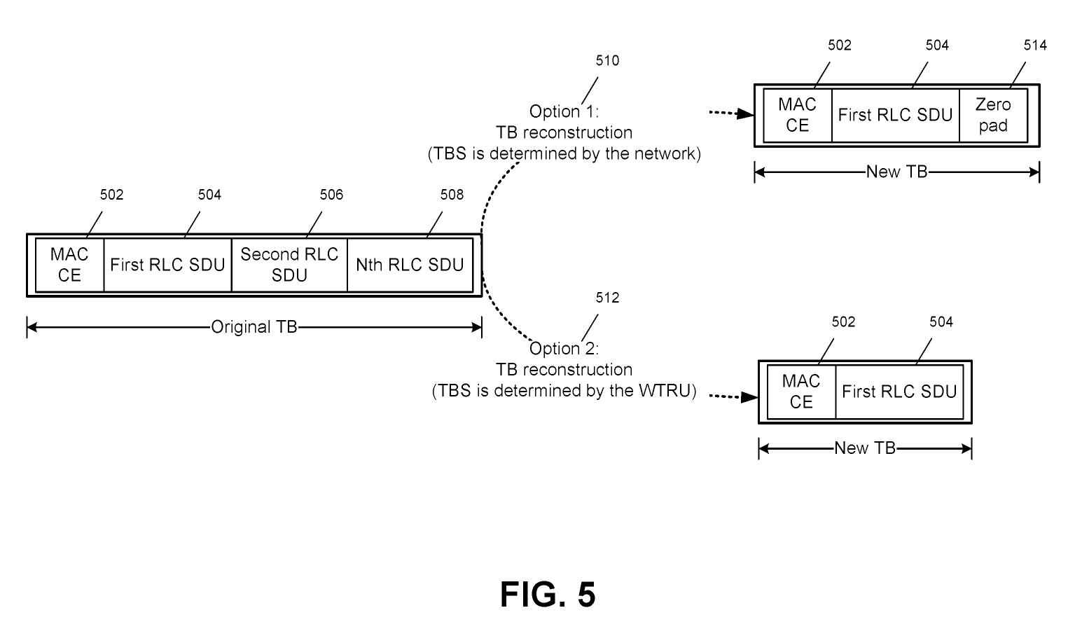

FIG. 5 illustrates an example of an original-TB-only multiplexing procedure for TB reconstruction. As shown in FIG. 5, the WTRU may (e.g., may first) perform transmission of an original TB, which may include a MAC-CE 502, a first RLC SDU 504, a second RLC SDU 506, and an nth RLC SDU 508. The WTRU may (e.g., may then) perform TB reconstruction for the original TB. The WTRU may have the MAC-CE 502 and the first RLC SDU 504 satisfying the retransmission condition. In option 1 at 510 of TB reconstruction (e.g., as shown in FIG. 5), in which the TBS may be implicitly indicated by the network, the WTRU may (e.g., may first) multiplex the MAC-CE 502 and first RLC SDU 504 in the second TB (e.g., new TB). The WTRU may perform zero-padding of the remaining resource(s) (e.g., afterwards) at 514. In option 2 at 512 of TB reconstruction (e.g. as shown in FIG. 5), in which the TBS may be determined by the WTRU and indicated to the network, the WTRU may (e.g., may first) multiplex the MAC-CE 502 and first RLC SDU 504 in the second TB (e.g., new TB). The WTRU may perform zero-padding of the remaining resource(s) (e.g., afterwards).

The WTRU may perform original-TB-prioritized multiplexing procedure for TB reconstruction, in which the WTRU may prioritize the control/data unit from the original TB before multiplexing other control/data units. The WTRU may first multiplex the control/data unit from the original TB (e.g., if reconstruction of a TB is triggered) in an order until the determined TB size and/or the control data/units (e.g., all the control/data units) in the original TB satisfying the retransmission criteria are multiplexed in a second TB (e.g., new TB). If there is still remaining resource(s), the WTRU may (e.g., may additionally) multiplex other control/data units (e.g., control/data units from other original TB for retransmission and/or control/data units for initial transmission).

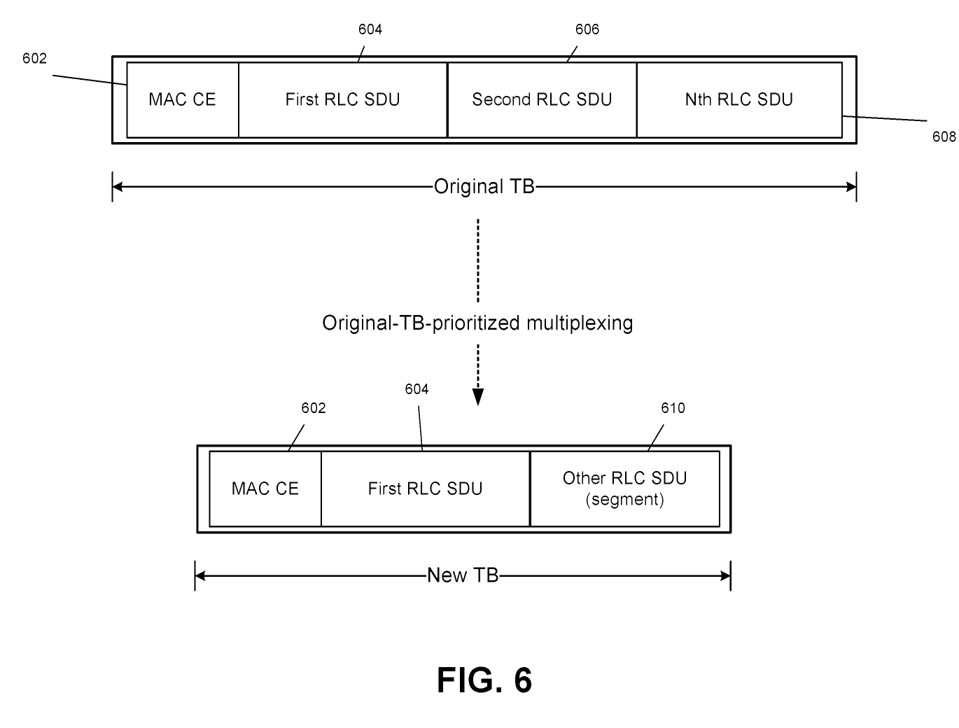

FIG. 6 illustrates an original-TB-prioritized multiplexing procedure for TB reconstruction. As shown in FIG. 6, the WTRU may first perform transmission of an original TB, which may include a MAC-CE 602, a first RLC SDU 604, a second RLC SDU 606, and an nth RLC SDU 608. The WTRU may (e.g., may then) perform TB reconstruction for the original TB using the original-TB-prioritized multiplexing procedure. The WTRU may have the MAC-CE 602 and the first RLC SDU 604 satisfying the retransmission condition. The WTRU may (e.g., may first) multiplex the MAC-CE 602 and the first RLC SDU 604 in a second TB (e.g., new TB). As there may still be resource(s) remaining, the WTRU may (e.g., may then) multiplex other RLC SDUs (segments) at 610, which may be originated from another TB, or which may be subject for initial transmission.

In examples, based on determining a TB reconstruction transmission for an original TB to transmit in a scheduled grant, the WTRU may (e.g., may then) determine which control/data units to consider/prioritize to multiplex in a second TB (e.g., new TB) based on one or more of the following: an indication/configuration from the network; or a QoS/QoS treatment profile associated with the control/data units.

For the indication/configuration from the network, the WTRU may be configured with a set of control/data units for TB reconstruction. The WTRU may (e.g., may then) consider (e.g., only consider) these configured control/data units for potential TB reconstruction.

For QoS/QoS treatment profile associated with the control/data units, the WTRU may prioritize the control/data unit to multiplex in a second TB (e.g., a new TB) based on the priority (e.g., relative priority) associated with the control/data unit. The WTRU may (e.g., may first) prioritize the control units (e.g., MAC-CE). The WTRU may (e.g., may then) prioritize high-importance/priority control/data. For example, the WTRU may prioritize the control/data unit to multiplex in a second TB (e.g., new TB) based on the delay budget (e.g., remaining delay budget) associated with the control/data unit. For example,

For QoS/QoS treatment profile associated with the control/data units, the WTRU may multiplex the control/data units for TB reconstruction if the priority/importance associated with the control/data unit is greater than a configured threshold. For example, the WTRU may multiplex the control/data units for TB reconstruction if the delay budget (e.g., remaining delay budget) associated with the control/data is smaller than a configured threshold.

The WTRU may (e.g., may then) determine whether to drop/discard the control/units (e.g., which may not multiplexed in a second TB (e.g., new TB) for TB reconstruction) based on one or more of the following: an indication from the network, the time elapse from initial transmission of the control/data unit, or the QoS associated with the control/data unit.

For the indication from the network, the WTRU may receive an indication from the network to flush the original HARQ ID. The WTRU may (e.g., may first) reconstruct one or more TBs (e.g., new TBs). The WTRU may (e.g., may then) discard the control/data units (e.g., all the control/data units) not multiplexed in TBs (e.g., new TBs).

For the time elapse from initial transmission of the control/data unit, the WTRU may be configured to flush a HARQ ID buffer if the time elapse from the initial transmission is larger than a configured threshold. The WTRU may (e.g., may then) discard the control/data units (e.g., all the control/data units) in the HARQ ID, which may be not multiplexed in a second TB (e.g. new TB) if the time elapse from the initial transmission of the TB is larger than a configured threshold.

For the QoS associated with the control/data unit, the WTRU may discard the control/data units discarded by upper layer (e.g., PDCP, RLC), which may stay in the buffer for a duration being greater than a threshold and/or which may be associated with an expired discard timer. For the QoS associated with the control/data unit, the WTRU may discard the control/data units not meeting the delay budget. For the QoS associated with the control/data unit, the WTRU may discard a control/data unit if the associated priority of the control/data unit is smaller than a configured threshold.

The WTRU may implicitly/explicitly report the set of dropped/discarded data units to the network. In examples, based on dropping one or more control/data units, the WTRU may report the set of remaining control/data units in its buffer. In examples, the WTRU may report the set of dopped/discarded control/data units. For example, the WTRU may report the amount dropped/discarded control/data unit in HARQ IDs (e.g., each HARQ ID). This approach may be motivated for the WTRU to stop scheduling a transmission resource for the dropped/discarded data.

The WTRU may perform the multiplexing procedure, which may consider/prioritize the control/data unit subject for a second-TB-based (e.g., new-TB-based) retransmission. In examples, the WTRU may perform a multiplexing procedure considering (e.g., only considering) the control/data units subject for second-TB-based (e.g., new-TB-based) retransmission. The WTRU may (e.g., may first) multiplex the control/data units subject for second-TB-based (e.g., new-TB-based retransmission). If there are resource(s) available, the WTRU may (e.g., may then) perform zero-padding. In examples, the WTRU may perform multiplexing procedure prioritizing the control/data units subject for second-TB-based (e.g., new-TB-based) retransmission. The WTRU may (e.g., may first) prioritize multiplexing the control/data units subject for second-TB-based (e.g., new-TB-based) retransmission. If there are resource(s) remaining, the WTRU may multiplex the control/data unit subject for initial transmission.

The WTRU may perform a multiplexing procedure considering/prioritizing the control/data units from the same QoS treatment profile groups. The WTRU may be configured (e.g., may be first configured) with one or more QoS treatment profile groups (e.g., LCG), in which each QoS treatment profile group may include one or more QoS treatment profile IDs (e.g., LCH IDs). QoS treatment profiles (e.g., each QoS treatment profile) may belong to one or more QoS treatment profile groups

The WTRU may perform the multiplexing procedure, which may consider/prioritize the control/data units from the same QoS treatment profile group. In examples, the WTRU may perform a multiplexing procedure considering (e.g., only considering) the control/data units from the same QoS treatment profile group. The WTRU may select control/data unit from one QoS treatment profile group to multiplex in a TB for transmission in a resource. In examples, the WTRU may select data units from one QoS treatment profile group to multiplex in a TB for transmission. The WTRU may multiplex in the TB control units associated with different QoS treatment profiles such as MAC-CE. The WTRU may not multiplex control units from other QoS treatment profiles. In examples, the WTRU may select (e.g., only select) control units (e.g., MAC-CE) to multiplex in a TB. If there are still resource(s) remaining, the WTRU may (e.g., may then) perform zero padding. In examples, the WTRU may perform a multiplexing procedure prioritizing the control/data units from the same QoS treatment profile group. For example, for multiplexing data unit in a TB, the WTRU may (e.g., may first) prioritize the data units associated with one QoS treatment profile group. The WTRU may (e.g., may then) multiplex data units from other QoS treatment profile group if there is no more data in the current QoS treatment profile group.

The WTRU may determine which QoS treatment profile group to consider/prioritize in the multiplexing procedure based on one or more of the following: an indication from the network, one or more QoS parameters associated with the QoS treatment profile groups, or the amount (e.g., relative amount) of control/data units associated with the QoS treatment profile.

For the indication from the network, the WTRU may be indicated by the network for which QoS treatment profile group to prioritize/consider. Such an indication may be conveyed via DCI.

For one or more QoS parameters associated with the QoS treatment profile group, the WTRU may be configured with a (priority (e.g., relative priority) for each QoS treatment profile group. In examples, WTRU may (e.g., may then) consider/prioritize the QoS treatment profile with the highest priority (e.g., highest relative priority). In examples, the WTRU may prioritize the QoS treatment profile group with the highest priority of the QoS treatment profile with data available.

For one or more QoS parameters associated with the QoS treatment profile group, the WTRU may consider/prioritize the QoS treatment profile having the control/data units with lowest delay budget (e.g., lowest remaining delay budget).

For the amount (e.g., relative amount) of control/data units associated with the QoS treatment profile, the WTRU may consider/prioritize a QoS treatment profile group if the amount (e.g., relative amount) of control/data associated with the QoS treatment profile group is greater than a configured threshold.

Examples for reporting the control/data information for retransmission are provided herein. The WTRU may trigger reporting the information about the control/data unit, which may have been transmitted but may have been acknowledged by the network. For example, the WTRU may use UCI (e.g., SR) to indicate the availability of the retransmission control/data. The WTRU may use MAC-CE to indicate the detailed information of the retransmission control/data. Such a report may be a retransmission buffer status reporting (RBSR) report. Such reported information may support the network in scheduling the retransmission resource for the WTRU. The WTRU may report one or more of the following information about the data/control unit(s) for potential retransmission (e.g., in SR or in RBSR) to the network: the availability of the control/data unit subject for retransmission; the amount of control/data subject for retransmission and potentially its associated QoS parameters; the amount/availability of retransmission control/data satisfying the configured condition; or the preferred transmission parameters (e.g., multiplexing procedure, TB size, MCS, resource size) for each TB reconstruction.

For the availability of the control/data unit subject for retransmission, which may include the availability of one or more TB subject for TB reconstruction transmission and/or the control/data unit subject for second-TB-based (e.g., new-TB-based) retransmission, the WTRU may use UCI (e.g., SR) to indicate the availability of the retransmission data/control unit(s).

For the amount of control/data subject for retransmission and potentially its associated QoS parameters, the WTRU may report the amount of control/data subject for both initial and retransmission and its associated QoS treatment (e.g., LCG ID) in one report (e.g., MAC-CE). The WTRU may indicate the amount of data/control for initial transmission and the amount of data/control for retransmission. For the amount of control/data subject for retransmission and potentially its associated QoS parameters, the WTRU may report the amount of control/data subject for retransmission and its associated QoS treatment (e.g., associated LCG ID, associated HARQ ID). The WTRU may report the control/data subject for retransmission in a second TB (e.g., new TB) (e.g., a second-TB-based/new-TB-based retransmission) and/or the control/data subject for TB reconstruction transmission.

For the amount of control/data subject for retransmission and potentially its associated QoS parameters, the WTRU may report the payload for MAC CE of a certain priority level included in the TB. For the amount of control/data subject for retransmission and potentially its associated QoS parameters, the WTRU may encode the amount of control/data as an index from which a TB size can be derived (e.g., table or formula). For the amount of control/data subject for retransmission and potentially its associated QoS parameters, the WTRU may include multiple values for the amount of control/data where each value may correspond to a set of priority levels. For example, the WTRU may include a first index corresponding to a first TB size that may carry (e.g., may only carry) control/data of highest priority level, and second index corresponding to a second TB size that may carry (e.g., may only carry) control/data of the two highest priority levels.

For the amount/availability of retransmission control/data satisfying the configured condition, the WTRU may report the HARQ ID(s) associated with the TBs subject to reconstruction. For the amount/availability of retransmission control/data satisfying the configured condition, the WTRU may report the amount of control/data for retransmission in each TB subject for TB reconstruction transmission. This approach may be motivated to support the network in scheduling resource for TB reconstruction transmission. For the amount/availability of retransmission control/data satisfying the configured condition, the WTRU may report the amount of control/data having QoS/QoS treatment profile satisfying a configured threshold/condition. For example, the WTRU may report the amount of delay-critical control/data for retransmission. The delay-critical control/data may be the control/data unit having the delay budget (e.g., the remaining delay budget) being smaller than a configured threshold. For example, the WTRU may report the amount of control/data associated with a configured set of QoS/QoS treatment profile (e.g., a set of RBs/LCHs, a set of RBs/LCHs having priority being greater than a configured threshold).

For the preferred transmission parameters (e.g., multiplexing procedure, TB size, MCS, resource size) for each TB reconstruction, in which each TB reconstruction may have an associated HARQ ID, the WTRU may trigger TB reconstruction for one or more TBs, in which each TB may have an associated HARQ ID. The WTRU may (e.g., may then) indicate its preferred transmission parameters for each TB reconstruction transmission. For example, the WTRU may indicate its preferred TB size for each HARQ ID. For example, the WTRU may indicate its preferred number of resources for transmission of each TB reconstruction.

The WTRU may be configured with one or more MAC-CE formats to report the RBSR information, in which MAC-CE formats (e.g., each MAC-CE format) may be used to convey one set of parameters and associated retransmission buffer status. The WTRU may be configured with a set of triggering conditions for each MAC-CE format. The WTRU may (e.g., may then) trigger transmission of the associated MAC-CE format upon the associated triggering condition being satisfied. For example, the WTRU may be configured with a MAC-CE format to report the delay information of the buffer for RBSR. The WTRU may be configured with another MAC-CE format to report the priority information of the buffer for RBSR.

The WTRU may be configured with one or more triggering conditions for transmission of UCI/MAC-CE (e.g., SR/RBSR) for reporting control/data units for retransmission. Based on the triggering condition being satisfied, the WTRU may trigger transmission of RBSR. The triggering condition may include one or more of the following events: the availability of control/data for retransmission; the QoS (e.g., delay budget (e.g., remaining delay budget) associated with the transmission control/data satisfying a configured threshold; one or more control/data units being discarded; a periodic reporting event; the availability of a transmission resource; or the initial transmission or retransmission of a TB for which TB reconstruction is supported.

For the availability of control/data for retransmission (e.g., the WTRU may trigger RBSR reporting if it has data/control subject for retransmission), in examples, the WTRU may trigger RBSR reporting if the WTRU has one or more TBs subject for TB reconstruction transmission. In examples, the WTRU may trigger RBSR reporting if the WTRU has control/data unit subject for second-TB-based (e.g., new-TB-based) retransmission.

For the QoS (e.g., delay budget or remaining delay budget) associated with the transmitted control/data satisfying a configured threshold, in examples, the WTRU may trigger RBSR reporting if the delay budget (e.g., remaining delay budget) of a control/data unit subject for retransmission is smaller than a configured threshold. In examples, the WTRU may trigger RBSR if the priority of the control/data subject for retransmission is larger than a configured threshold.

For one or more control/data units being discarded, the WTRU may trigger RBSR if one or more control/data units are discarded/deprioritized.

For a periodic reporting event, the WTRI may be configured to periodically report RBSR. The WTRU may (e.g., may then) trigger RBSR after a configured duration from the previous RBSR reporting. For example, the WTRU may start a timer (e.g., periodic reporting timer) when transmitting a RBSR. The WTRU may (e.g., may then) trigger transmission of RBSR when the timer expires.

For the availability of a transmission resource, the WTRU may trigger transmission of RBSR if the WTRU has resource(s) for transmission. In examples, if the WTRU still has resource(s) for transmission after multiplexing control/data for a TB, the WTRU may opportunistically include RBSR in the TB for transmission.

For initial transmission or retransmission of a TB for which TB reconstruction is supported, the WTRU may multiplex RBSR as UCI in any PUSCH in which a TB is multiplexed if TB reconstruction is supported for this TB. For initial transmission or retransmission of a TB for which TB reconstruction is supported, the WTRU may multiplex RBSR as UCI in any PUSCH if TB reconstruction is configured for the corresponding HARQ process.

In examples, the WTRU may trigger transmission of UCI (e.g., SR) if there is no uplink grant within a period based on the retransmission buffer status reporting being triggered. In examples, the UE may trigger transmission of UCI (e.g., SR) based on the availability of the control/data unit subject for retransmission, which may include the availability of one or more TBs subject for TB reconstruction transmission and/or the control/data units subject for second-TB-based (e.g., new-TB-based) retransmission. In examples, the WTRU may be configured with a dedicated UCI (e.g., SR) resource to trigger retransmission of a buffer report. In examples, the WTRU may be configured with a shared UCI (e.g., SR) resource for triggering of RBSR and potential other reporting such as other MAC-CE, BSR, DSR.

If RBSR is triggered, the WTRU may keep the RBSR until it is cancelled. If RBSR is not cancelled, the WTRU may keep transmitting the RBSR if the WTRU has available resource(s) for transmission of RBSR report. The WTRU may (e.g., may then) cancel RBSR based on one or more of the following: the buffer status of the control/data units triggering the RBSR being included in the RBSR report; or the control/data units subject for retransmission triggering the RBSR being transmitted in at least one part of a resource.

A WTRU may (e.g., if the WTRU receives a grant for retransmission of one or more control/data units in a TB) select a set of control/data units (e.g., a MAC-CE, a RLC SDU, a MAC SDU) from the TB (e.g., original TB) for a TB reconstruction transmission in a scheduled resource based on a triggering condition (e.g., an indication from the network, a QoS of the TB, a power transmission condition, a channel condition) for TB reconstruction transmission being satisfied.

A WTRU may receive configuration information. The configuration information may include (e.g., indicate) at least one trigger condition for TB reconstruction transmission and/or one or more conditions for retransmission of control/data units (e.g., retransmission of control/data units from a first TB (e.g., original TB)). The one or more trigger conditions for TB reconstruction transmission may include an indication from the network, a QoS of the TB related condition (e.g., latency, priority, importance thresholds), a power and/or channel related condition. For the indication from the network, the WTRU may be configured with a DCI format for implicit or explicit indication to retransmit one or more control/data units in a TB (e.g., sub-TB retransmission). For the QoS of the TB related condition (e.g., latency, priority, importance thresholds), the WTRU may be configured with a latency threshold. The WTRU may transmit a control/data unit again (e.g., in a second TB/new TB) if the delay budget (e.g., remaining delay budget) of the data/control unit is smaller than the latency threshold. For the power and/or channel related condition, the WTRU may be configured with a Tx power difference threshold, in which the WTRU may perform sub-TB retransmission of one or more control/data units if the Tx power difference between the initial and the retransmission is larger than the power difference threshold.

The one or more conditions for retransmission of a control/data units from the original TB may include the WTRU retransmitting the control/data units if the delay budget (e.g., remaining delay budget) is smaller than a configured threshold (e.g., latency threshold) or the WTRU retransmitting the control/data units if an associated priority is smaller than a configured threshold (e.g., priority threshold). The remaining delay budget may be based on a remaining time until a discard timer expires at higher layers (e.g., PDCP) or in a MAC layer.

The WTRU may construct a TB (e.g., a first TB or an original TB) and may perform initial transmission of the TB (e.g., the first TB or the original TB) (e.g., based on receiving a grant for initial transmission of a TB). The WTRU may receive a scheduling grant. The scheduling grant may be used to retransmit one or more control/data units of the TB (e.g., the first TB or the original TB).

The WTRU may determine to perform TB reconstruction transmission based on the at least one trigger condition for TB reconstruction transmission being satisfied. The WTRU may determine which control/data units (e.g., MAC-CE, MAC SDU, MAC subPDU) of the first TB (e.g., the original TB) to retransmit based on the one or more trigger conditions to retransmit the control/data unit being satisfied. The one or more trigger conditions for TB reconstruction transmission being satisfied may include an indication from the network being received, a QoS related condition being satisfied, a power related condition being satisfied, or a channel related condition being satisfied. The indication from the network may be a DCI format to use for (e.g., configured to indicate) the retransmission of the one or more control/data units. The power related condition being satisfied may be a power difference between an initial transmission and retransmission being larger than a power difference threshold. In examples, the QoS related condition being satisfied may be a delay budget of the one or more control/data units being smaller than a latency threshold. In examples, the QoS related condition being satisfied may be a priority of the one or more control/data units being smaller than a priority threshold. The one or more conditions for retransmission of one or more control/data units being satisfied may include a remaining delay budget of the one or more control/data units being smaller than a latency threshold or a priority of the one or more control/data units being smaller than a priority threshold. The one or more control/data units may include a MAC-CE, a MAC SDU, a RLC PDU, or a MAC subPDU.

The WTRU may construct a TB (e.g., a second TB) including the control/data units to be retransmitted (e.g., from the first TB). The WTRU may transmit the determined TB (e.g., the second TB). The second TB may be a subset of the TB or the entire TB. The second TB, including the one or more control/data units retransmitted from the first TB, may be transmitted in the scheduled grant.

The WTRU may use the same or a different HARQ process ID to transmit the control/data unit again (e.g., based on network indication). If the WTRU uses the same HARQ ID, the WTRU may (e.g., may need to) flush the existing HARQ ID and discard other data. If the WTRU uses a different HARQ ID, the network may (e.g., may need to) indicate which HARQ ID and the relationship with the existing HARQ ID. For example, a type (e.g., new type) of NDI may be used to tell the WTRU to flush the HARQ process but keep the data in the buffer.

The WTRU may indicate (e.g., transmit) the information associated with the second TB (e.g., new TB) (e.g., in a separate part of the resource (e.g., UCI)). The information associated with the second TB may include at least one of whether the WTRU retransmits a subset of a TB or the entire TB (e.g., whether the second TB is a subset of the first TB or is an entire TB); or one or more of (e.g., a new) TBS, MCS, or subset of resources used for transmission.

The examples described herein may enable the WTRU to accelerate (re)transmission of a subset of a TB at a lower layer (e.g., PHY) instead of waiting for a higher layer (e.g., RLC/PDCP) (re)transmission, which may incur long delay. The examples herein may help the WTRU to deliver important data within the latency requirement.

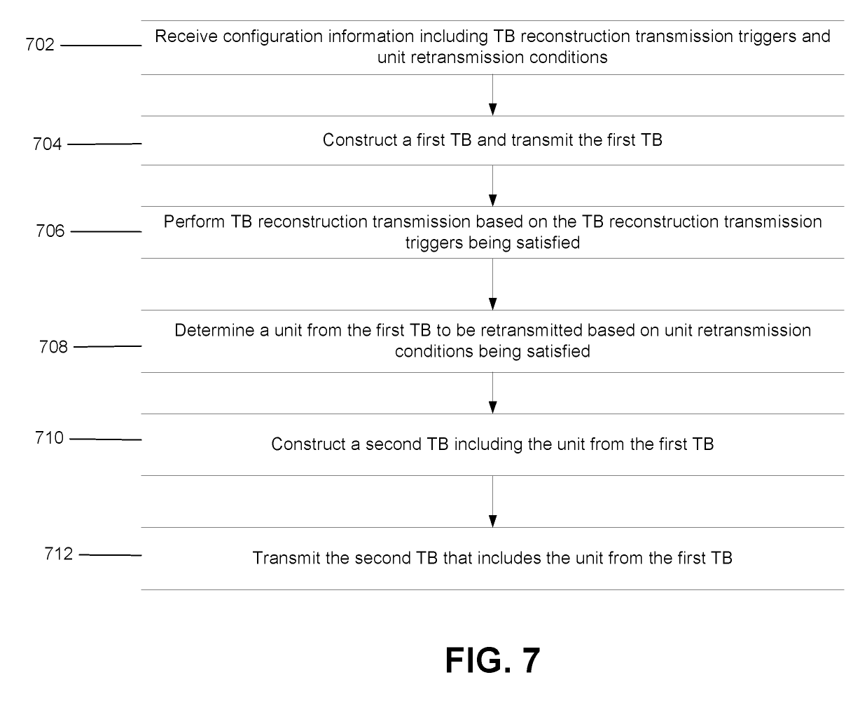

FIG. 7 illustrates an example associated with TB reconstruction transmission, where one or more of the illustrated actions may be performed. At 702, a WTRU may receive configuration information. The configuration information may include at least one trigger condition to perform transport block (TB) reconstruction transmission and one or more conditions associated with unit retransmission. At 704, the WTRU may construct a first TB and transmit the first TB. At 706, the WTRU may determine to perform TB reconstruction transmission based on the at least one trigger condition for TB reconstruction transmission being satisfied. At 708, the WTRU may determine a unit from the first TB to be retransmitted based on the one or conditions for retransmission being satisfied. At 710, the WTRU may construct a second TB. The second TB may include the unit from the first TB. At 712, the WTRU may transmit the second TB that includes the unit from the first TB.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is Claimed:

1. A wireless transmit/receive unit (WTRU), comprising:
a processor configured to:
receive configuration information, wherein the configuration information comprises at least one trigger condition to perform transport block (TB) reconstruction transmission and one or more conditions associated with unit retransmission;
construct a first TB and transmit the first TB;
determine to perform TB reconstruction transmission based on the at least one trigger condition for TB reconstruction transmission being satisfied;
determine a unit from the first TB to be retransmitted based on the one or more conditions associated with unit retransmission being satisfied;
construct a second TB, wherein the second TB includes the unit from the first TB; and
transmit the second TB that includes the unit from the first TB.

2. The WTRU of claim 1, wherein the at least one trigger condition to perform TB reconstruction transmission being satisfied includes: an indication from a network being received, a quality of service (QoS) related condition being satisfied, a power related condition being satisfied, or a channel related condition being satisfied.

3. The WTRU of claim 2, wherein the power related condition being satisfied is a power difference between an initial transmission and retransmission being larger than a power difference threshold.

4. The WTRU of claim 2, wherein the indication from the network is determined to be received based on a received downlink control information (DCI) using a configured DCI format.

5. The WTRU of claim 1, wherein the one or more conditions associated with unit retransmission being satisfied includes a remaining delay budget of the unit being smaller than a latency threshold or a priority of the unit being smaller than a priority threshold.

6. The WTRU of claim 5, wherein the remaining delay budget is based on a remaining time until a discard timer expires at a higher layer or in a medium access control (MAC) layer.

7. The WTRU of claim 1, wherein the unit includes a MAC control element (CE), a MAC service data unit (SDU), a radio link control protocol data unit (RLC PDU), or a MAC sub protocol data unit (subPDU).

8. The WTRU of claim 1, wherein the second TB is a subset of the first TB.

9. The WTRU of claim 1, wherein the processor is further configured to:
transmit information associated with the second TB, wherein the information associated with the second TB includes at least one of:
an indication of whether the second TB is a subset of the first TB, or
an indication of at least one of a transport block size (TBS), an modulation and coding scheme (MCS), or a subset of resources used for transmitting the second TB.

10. The WTRU of claim 1, wherein the processor is further configured to:
receive a scheduling grant, wherein the second TB that includes the unit from the first TB is transmitted in resources indicated by the scheduling grant.

11. A method associated with wireless transmit/receive unit (WTRU), the method comprising:
receiving configuration information, wherein the configuration information comprises at least one trigger condition to perform transport block (TB) reconstruction transmission and one or more conditions associated with unit retransmission;
constructing a first TB and transmitting the first TB;
determining to perform TB reconstruction transmission based on the at least one trigger condition for TB reconstruction transmission being satisfied;
determining a unit from the first TB to be retransmitted based on the one or more conditions associated with unit retransmission being satisfied;
constructing a second TB, wherein the second TB includes the unit from the first TB; and
transmitting the second TB that includes the unit from the first TB.

12. The method of claim 11, wherein the at least one trigger condition to perform TB reconstruction transmission being satisfied includes: an indication from a network being received, a quality of service (QoS) related condition being satisfied, a power related condition being satisfied, or a channel related condition being satisfied.

13. The method of claim 12, wherein the power related condition being satisfied is a power difference between an initial transmission and retransmission being larger than a power difference threshold.

14. The method of claim 12, wherein the indication from the network is determined to be received based on a received downlink control information (DCI) using a configured DCI format.

15. The method of claim 11, wherein the one or more conditions associated with unit retransmission being satisfied includes a remaining delay budget of the unit being smaller than a latency threshold or a priority of the unit being smaller than a priority threshold.

16. The method of claim 15, wherein the remaining delay budget is based on a remaining time until a discard timer expires at a higher layer or in a medium access control (MAC) layer.

17. The method of claim 11, wherein the unit includes a MAC control element (CE), a MAC service data unit (SDU), a radio link control protocol data unit (RLC PDU), or a MAC sub protocol data unit (subPDU).

18. The method of claim 11, wherein the second TB is a subset of the first TB.

19. The method of claim 11, further comprising:
transmitting information associated with the second TB, wherein the information associated with the second TB includes at least one of:
an indication of whether the second TB is a subset of the first TB, or
an indication of at least one of a transport block size (TBS), an modulation and coding scheme (MCS), or a subset of resources used for transmitting the second TB.

20. The method of claim 11, further comprising:
receiving a scheduling grant, wherein the second TB that includes the unit from the first TB is transmitted in resources indicated by the scheduling grant.
